(19) United States
(12) Patent Application Publication
(10) Pub. No.: US 2021/0319643 A1
(43) Pub. Date: Oct. 14, 2021

(54) BANKNOTE PROCESSING DEVICE AND METHODS

(71) Applicant: Cummins-Allison Corp., Mt. Prospect, IL (US)

(72) Inventors: Marek Baranowski, Shamong, NJ (US); John Mikkelsen, Langhorne, PA (US)

(21) Appl. No.: 17/301,602

(22) Filed: Apr. 8, 2021

Related U.S. Application Data
(60) Provisional application No. 63/007,785, filed on Apr. 9, 2020.

(51) Int. Cl. G07D 11/14; G07D 11/18; G07D 11/40

(52) U.S. Cl. CPC G07D 11/14; G07D 11/18; G07D 7/12; G07D 2211/00; G07D 2207/00; G07D 11/40

(57) ABSTRACT

A banknote processing device includes an output receptacle module, including side walls, each side wall including a flange, wherein each flange includes an aperture, a first transport plate, and a transport motor. The banknote processing device further includes a common input and discrimination module including a shaft releasably received in the aperture of each flange of the side walls of the output receptacle module, a drive shaft having one or more driven rollers coupled thereto, and a second transport plate which together with the first transport plate defines a transport path between the first and second transport plates, wherein the one or more driven rollers move banknotes along the transport path between the second and first transport plates.

### CROSS-REFERENCE TO RELATED APPLICATIONS

This application claims priority to and the benefit of U.S. Provisional Patent Application No. 63/007,785, filed Apr. 9, 2020, entitled BANKNOTE PROCESSING DEVICE AND METHODS, the entire contents of which are herein incorporated by reference.

### TECHNICAL FIELD

The present disclosure relates generally to banknote or currency bill processing devices and related methods.

### BACKGROUND

Previous banknote or currency bill processing devices have various shortcomings.

### SUMMARY

In one aspect, an output receptacle module for a banknote processing device includes one or more output receptacles, side walls, each side wall comprising a flange, each flange having an opening therein and each flange defining an aperture into which a shaft of a common input and discrimination module may be received, a fourth transport plate which together with a third transport plate of the common input and discrimination module defines a transport path between the third and fourth transport plates, and a transport motor, wherein the output receptacle module is configured to have the common input and discrimination module releasably coupled thereto.

In some embodiments, the banknote processing device includes the output receptacle module, the common input and discrimination module coupled thereto, wherein the shaft of a common input and discrimination module is received in the apertures of the flanges of the side walls of the output receptacle module, and a drive belt coupled between a transport motor shaft of the transport motor and a drive shaft of the common input and discrimination module, the drive shaft having one or more driven rolls coupled thereto, wherein the one or more driven rolls act to move banknotes along the transport path between the third and fourth transport plates.

In another aspect, a banknote processing device includes an output receptacle module including side walls, each side wall including a flange, wherein each flange includes an aperture, a first transport plate and a transport motor. The banknote processing device further includes a common input and discrimination module including a shaft releasably received in the aperture of each flange of the side walls of the output receptacle module, a drive shaft having one or more driven rollers coupled thereto, and second transport plate which together with the first transport plate of the output receptacle module defines a transport path between the first and second transport plates, wherein the one or more driven rollers move banknotes along the transport path between the second and first transport plates.

In some embodiments, the common input and discrimination module is pivotally mounted about the drive shaft to permit the common input and discrimination module to be moved from an operational position to a non-operational position, wherein when the common input and discrimination module is positioned in the operational position, the first and second transport plates are spaced slightly apart from each other and the driven rollers extend through openings in the second transport plate into the transport path between the first and second transport plates, and wherein when the common input and discrimination module is positioned in the non-operational position, at least portions of the first and second transport plates are moved away from each other to provide access to the transport path.

In some embodiments, the output receptacle module further includes a full output receptacle, the full output receptacle including a stacking wheel associated therewith to assist with stacking banknotes in the full output receptacle.

In some embodiments, the output receptacle module further includes a full output receptacle and a partial output receptacle, the full output receptacle including a stacking wheel associated therewith to assist with stacking banknotes in the full output receptacle, and the partial output receptacle not including a stacking wheel associated therewith.

In some embodiments, the output receptacle module further includes a diverter operable to move between a first position and a second position, wherein, when in the first position, the diverter diverts banknotes to a first portion of the transport path leading to the partial output receptacle, and wherein, when in the second position, the diverter diverts banknotes to a second portion of the transport path leading to the full output receptacle.

In some embodiments, the output receptacle module further includes two full output receptacles, each full output receptacle including a stacking wheel associated therewith to assist with stacking banknotes in the associated full output receptacle.

In some embodiments, the output receptacle module further includes a diverter operable to move between a first position and a second position, wherein, when in the first position, the diverter diverts banknotes to a first portion of the transport path leading to one of the full output receptacles, and wherein, when in the second position, the diverter diverts banknotes to a second portion of the transport path leading to another one of the full output receptacles.

In some embodiments, the output receptacle module further includes a partial output receptacle and two full output receptacles, each full output receptacle including a stacking wheel associated therewith to assist with stacking banknotes in the associated full output receptacle, and the partial output receptacle not including a stacking wheel associated therewith.

In some embodiments, the output receptacle module further includes a first diverter operable to move between a first position and a second position, wherein, when in the first position, the first diverter diverts banknotes to a first portion of the transport path leading to the partial output receptacle, and wherein, when in the second position, the first diverter diverts banknotes to a second portion of the transport path leading to the full output receptacles and a second diverter operable to move between a third position and a fourth position, wherein, when in the third position, the second diverter diverts banknotes to a third portion of the transport path leading to one of the full output receptacles, and wherein, when in the fourth position, the second diverter diverts banknotes to a fourth portion of the transport path leading to another one of the full output receptacles.

In another aspect, an output receptacle module for a banknote processing device includes side walls, each side wall including a flange, wherein each flange includes an aperture into which a shaft of a common input and discrimination module is releasably coupled thereto, a first transport plate which together with a second transport plate of the common input and discrimination module defines a transport path between the second and first transport plates, a transport motor operable to drive a plurality of rollers to transport banknotes along the transport path, and one or more output receptacles disposed at an end of the transport path and operable to receive the transported banknotes.

In some embodiments, the one or more output receptacles includes a full output receptacle, the full output receptacle including a stacking wheel associated therewith to assist with stacking banknotes in the full output receptacle.

In some embodiments, the one or more output receptacles includes a full output receptacle and a partial output receptacle, the full output receptacle including a stacking wheel associated therewith to assist with stacking banknotes in the full output receptacle, and the partial output receptacle not including a stacking wheel associated therewith.

In some embodiments, the output receptacle module further includes a diverter operable to move between a first position and a second position, wherein, when in the first position, the diverter diverts banknotes to a first portion of the transport path leading to the partial output receptacle, and wherein, when in the second position, the diverter diverts banknotes to a second portion of the transport path leading to the full output receptacle.

In some embodiments, the one or more output receptacles includes two full output receptacles, each full output receptacle including a stacking wheel associated therewith to assist with stacking banknotes in the associated full output receptacle.

In some embodiments, the output receptacle module further includes a diverter operable to move between a first position and a second position, wherein, when in the first position, the diverter diverts banknotes to a first portion of the transport path leading to one of the two full output receptacles, and wherein, when in the second position, the diverter diverts banknotes to a second portion of the transport path leading to another one of the two full output receptacles.

In some embodiments, the one or more output receptacles includes a partial output receptacle and two full output receptacles, each full output receptacle including a stacking wheel associated therewith to assist with stacking banknotes in the associated full output receptacle, and the partial output receptacle not including a stacking wheel associated therewith.

In some embodiments, the output receptacle module further includes a first diverter operable to move between a first position and a second position, wherein, when in the first position, the first diverter diverts banknotes to a first portion of the transport path leading to the partial output receptacle, and wherein, when in the second position, the first diverter diverts banknotes to a second portion of the transport path leading to the two full output receptacles and a second diverter operable to move between a third position and a fourth position, wherein, when in the third position, the second diverter diverts banknotes to a third portion of the transport path leading to one of the two full output receptacles, and wherein, when in the fourth position, the second diverter diverts banknotes to a fourth portion of the transport path leading to another one of the two full output receptacles.

In some embodiments, the side walls further include guide flanges including elongated slots for receiving guide posts of the common input and discrimination module, wherein the elongated slots allow for guide posts to move within the elongated slots when the common input and discrimination module moves to a raised position.

In another aspect, a banknote processing device includes an output receptacle module including a first transport plate and side walls that each include a flange having an aperture therethrough, the banknote processing device further including a common input and discrimination module including a second transport plate and a shaft releasably received in the aperture of each flange of the side walls of the output receptacle module, and a method of a banknote processing device includes rotating the common input and discrimination module about the shaft releasably received into the apertures of the side walls of the output receptacle module into an operational position. The method further includes receiving, by the common input and discrimination module, one or more banknotes. The method further includes transporting the one or more banknotes along a transport path from the common input and discrimination module to the output receptacle module, wherein the transport path is defined by the second transport plate of the common input and discrimination module and the first transport plate of the output receptacle module. The method further includes transporting the one or more banknotes along the transport path to at least one output receptacle of the output receptacle module.

In some embodiments, the at least one output receptacle includes a plurality of output receptacles, and transporting the one or more banknotes includes moving a diverter included within the output receptacle module and disposed at a position in the transport path between a first position and a second position, diverting, when the diverter is in the first position, at least one banknote of the one or more banknotes to a first portion of the transport path leading to one of the plurality of output receptacles, and diverting, when the diverter is in the second position, at least one banknote of the one or more banknotes to a second portion of the transport path leading to another one of the plurality of output receptacles.

In another aspect, a banknote processing device includes an output receptacle module including side walls, each side wall including a flange, wherein each flange includes an aperture, a first transport plate and a transport motor. The banknote processing device further includes a common input and discrimination module including a shaft releasably received in the aperture of each flange of the side walls of the output receptacle module, a drive belt coupled between a transport motor shaft of the transport motor and a drive shaft of the common input and discrimination module, the drive shaft having one or more driven rollers coupled thereto, and second transport plate which together with the first transport plate of the output receptacle module defines a transport path between the first and second transport plates, wherein the one or more driven rollers move banknotes along the transport path between the second and first transport plates.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure, reference is now made to the following description, taken in conjunction with the accompanying drawings, in which:

FIG. 1 illustrates a cross-sectional view of select components of a common input and discrimination module and an output module for a banknote processing device in accordance with various embodiments of this disclosure;

FIG. 2A illustrates a first side or right-side perspective view of select components of a common input and discrimination module for a banknote processing device in accordance with various embodiments of this disclosure;

FIG. 2B illustrates a second side or left-side perspective view of select components of a common input and discrimination module for a banknote processing device in accordance with various embodiments of this disclosure;

FIG. 2C illustrates a right-side view of select components of a common input and discrimination module for a banknote processing device in accordance with various embodiments of this disclosure;

FIG. 2D illustrates a left-side view of select components of a common input and discrimination module for a banknote processing device in accordance with various embodiments of this disclosure;

FIG. 3 illustrates examples of some components of a banknote processing device in accordance with various embodiments of this disclosure;

FIG. 4 illustrates a cross-sectional view of select components of a banknote processing device including a common input and discrimination module and an output receptacle module including a single full output receptacle in accordance with various embodiments of this disclosure;

FIG. 5 illustrates a cross-sectional view of select components of a banknote processing device including a common input and discrimination module and an output receptacle module including a full output receptacle and a partial output receptacle in accordance with various embodiments of this disclosure;

FIG. 6 illustrates a cross-sectional view of select components of a banknote processing device including a common input and discrimination module and an output receptacle module including two full output receptacles in accordance with various embodiments of this disclosure;

FIG. 7A illustrates a perspective view of a first side or right-hand side of an output receptable module including a single full output receptacle in accordance with various embodiments of this disclosure;

FIG. 7B illustrates a perspective view of a second side or left-hand side of an output receptable module including single full output receptacle in accordance with various embodiments of this disclosure;

FIG. 7C illustrates a perspective view of a first side or right-hand side of a banknote processing device including an output receptacle module including single full output receptacle in an operational condition in accordance with various embodiments of this disclosure;

FIG. 7D illustrates a perspective view of a second side or left-hand side of the banknote processing device including an output receptacle module including single full output receptacle in the operational condition in accordance with various embodiments of this disclosure;

FIG. 7E illustrates a cross-sectional view of a banknote processing device including an output receptacle module including single full output receptacle in the operational condition in accordance with various embodiments of this disclosure;

FIG. 7F illustrates a perspective view of a banknote processing device including an output receptacle module including single full output receptacle in a non-operational condition in accordance with various embodiments of this disclosure;

FIG. 7G illustrates a perspective view of a banknote processing device including an output receptacle module including single full output receptacle in another non-operational condition in accordance with various embodiments of this disclosure;

FIG. 7H illustrates a perspective view of a banknote processing device including an output receptacle module including single full output receptacle in another non-operational condition in accordance with various embodiments of this disclosure;

FIG. 7I illustrates a side view of a banknote processing device including an output receptacle module including single full output receptacle in another non-operational condition in accordance with various embodiments of this disclosure;

FIG. 8A illustrates a perspective view of a first side or right-hand side of an output receptable module including a full output receptacle and a partial output receptacle in accordance with various embodiments of this disclosure;

FIG. 8B illustrates a perspective view of a second side or left-hand side of an output receptable module including a full output receptacle and a partial output receptacle in accordance with various embodiments of this disclosure;

FIG. 8C illustrates a perspective view of a first side or right-hand side of a banknote processing device including an output receptacle module including a full output receptacle and a partial output receptacle in an operational condition in accordance with various embodiments of this disclosure;

FIG. 8D illustrates a perspective view of a second side or left-hand side of the banknote processing device including an output receptacle module including a full output receptacle and a partial output receptacle in the operational condition in accordance with various embodiments of this disclosure;

FIG. 8E illustrates a cross-sectional view of a banknote processing device including an output receptacle module including a full output receptacle and a partial output receptacle in the operational condition in accordance with various embodiments of this disclosure;

FIG. 8F illustrates a perspective view of a banknote processing device including an output receptacle module including a full output receptacle and a partial output receptacle in a non-operational condition in accordance with various embodiments of this disclosure;

FIG. 8G illustrates a perspective view of a banknote processing device including an output receptacle module including a full output receptacle and a partial output receptacle in another non-operational condition in accordance with various embodiments of this disclosure;

FIG. 8H illustrates a perspective view of a banknote processing device including an output receptacle module including a full output receptacle and a partial output receptacle in another non-operational condition in accordance with various embodiments of this disclosure;

FIG. 8I illustrates a side view of a banknote processing device including an output receptacle module including a full output receptacle and a partial output receptacle in another non-operational condition in accordance with various embodiments of this disclosure;

FIG. 9A illustrates a perspective view of a first side or right-hand side of an output receptable module including two full output receptacles in accordance with various embodiments of this disclosure;

FIG. 9B illustrates a perspective view of a second side or left-hand side of an output receptable module including two full output receptacles in accordance with various embodiments of this disclosure;

FIG. 9C illustrates a perspective view of a first side or right-hand side of a banknote processing device including an output receptable module including two full output receptacles in an operational condition in accordance with various embodiments of this disclosure;

FIG. 9D illustrates a perspective view of a second side or left-hand side of the banknote processing device an output receptable module including two full output receptacles in the operational condition in accordance with various embodiments of this disclosure;

FIG. 9E illustrates a cross-sectional view of a banknote processing device an output receptable module including two full output receptacles in the operational condition in accordance with various embodiments of this disclosure;

FIG. 9F illustrates a perspective view of a banknote processing device including an output receptable module including two full output receptacles in a non-operational condition in accordance with various embodiments of this disclosure;

FIG. 9G illustrates a perspective view of a banknote processing device including an output receptable module including two full output receptacles in another non-operational condition in accordance with various embodiments of this disclosure;

FIG. 9H illustrates a perspective view of a banknote processing device including an output receptable module including two full output receptacles in another non-operational condition in accordance with various embodiments of this disclosure;

FIG. 9I illustrates a side view of a banknote processing device including an output receptable module including two full output receptacles in another non-operational condition in accordance with various embodiments of this disclosure;

FIG. 10 is a side sectional view of select components of a banknote processing device including a common input and discrimination module and an output receptacle module including a partial output receptacle and two full output receptacles in accordance with various embodiments of this disclosure;

FIG. 11A illustrates a perspective view of a banknote processing device including a common input and discrimination module and an output receptacle module including a single full output receptacle in accordance with various embodiments of this disclosure;

FIG. 11B illustrates a side view of a banknote processing device including a common input and discrimination module and an output receptacle module including a single full output receptacle in accordance with various embodiments of this disclosure;

FIG. 11C illustrates a front view of a banknote processing device including a common input and discrimination module and an output receptacle module including a single full output receptacle in accordance with various embodiments of this disclosure;

FIG. 11D illustrates a top view of a banknote processing device including a common input and discrimination module and an output receptacle module including a single full output receptacle in accordance with various embodiments of this disclosure;

FIG. 12A illustrates a perspective view of a banknote processing device including a common input and discrimination module and an output receptacle module including a full output receptacle and a partial output receptacle in accordance with various embodiments of this disclosure;

FIG. 12B illustrates a side view of a banknote processing device including a common input and discrimination module and an output receptacle module including a full output receptacle and a partial output receptacle in accordance with various embodiments of this disclosure;

FIG. 12C illustrates a front view of a banknote processing device including a common input and discrimination module and an output receptacle module including a full output receptacle and a partial output receptacle in accordance with various embodiments of this disclosure;

FIG. 12D illustrates a top view of a banknote processing device including a common input and discrimination module and an output receptacle module including a full output receptacle and a partial output receptacle in accordance with various embodiments of this disclosure;

FIG. 13A illustrates a perspective view of a banknote processing device including a common input and discrimination module and an output receptacle module including two full output receptacles in accordance with various embodiments of this disclosure;

FIG. 13B illustrates a side view of a banknote processing device including a common input and discrimination module and an output receptacle module including two full output receptacles in accordance with various embodiments of this disclosure;

FIG. 13C illustrates a front view of a banknote processing device including a common input and discrimination module and an output receptacle module including two full output receptacles in accordance with various embodiments of this disclosure; and

FIG. 13D illustrates a top view of a banknote processing device including a common input and discrimination module and an output receptacle module including two full output receptacles in accordance with various embodiments of this disclosure.

### DETAILED DESCRIPTION

According to various embodiments of this disclosure, a common input and discrimination module is provided that is designed to work with different output receptacle modules having different numbers and/or types of output receptacles such as output receptacle modules having one, two, or more output receptacles. According to some embodiments, a banknote processing device includes a common input and discrimination module designed to work with different output receptacle modules having different numbers and/or types of output receptacles such as output receptacle modules having one, two, or more output receptacles.

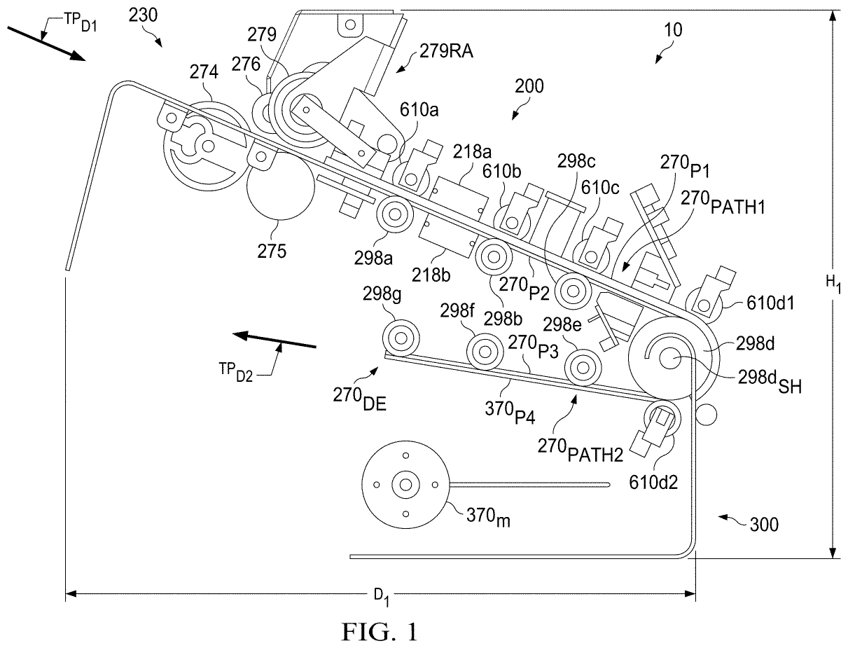

FIG. 1 illustrates a cross-sectional view of select components of a common input and discrimination module 200 and an output module 300 for a banknote processing device 10 in accordance with various embodiments of this disclosure. Operation of banknote processing devices and their components is described in U.S. Patent Application Publication No. 2020/0327763, dated Oct. 15, 2020, which is incorporated herein by reference in its entirety. According to some embodiments, the banknote processing device 10 of this disclosure may include the various features described in U.S. Patent Application Publication No. 2020/0327763, such as, for example, the time-of-flight (“ToF”) sensors 32, 34, the magnetic encoder 797, the shaft adjustment mechanism 800 having a rack and pinion type alignment system including for, example, an adjustment plate 810, one or more light sources positioned in or adjacent to one or more output receptacles which may illuminate a respective output receptacle 40 with a plurality of different colors and/or a plurality of intensities or modulation patterns, the idler roller beams 605 and/or idler clip or spring cleats 630, the QR code system, the hopper extension bracket 316, the feeder plate 314, the feeder bracket 312, and/or the stacker tray 440 described in U.S. Patent Application Publication No. 2020/0327763.

Operation of banknote processing devices and their components is also described in, and, according to some embodiments, the banknote processing device 10 of this disclosure may include various features described in, U.S. Pat. No. 5,815,592, which is incorporated herein by reference in its entirety. Operation of banknote processing devices and their components is also described in, and, according to some embodiments, the banknote processing device 10 of this disclosure may include various features described in, U.S. Pat. No. 5,790,697, which is incorporated herein by reference in its entirety, including the modes of operation described therein (e.g., Mixed Mode, Stranger Mode, etc.).

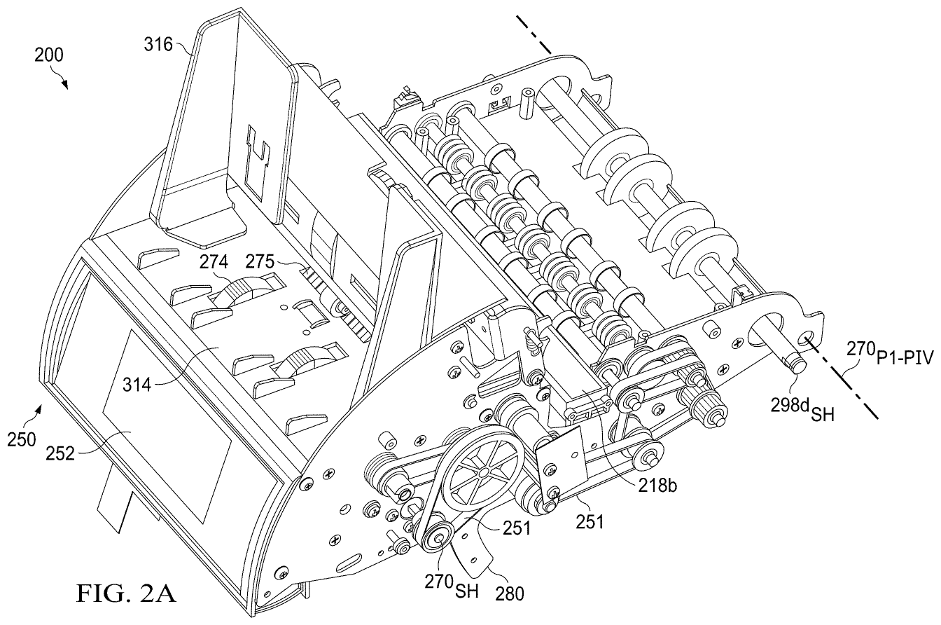

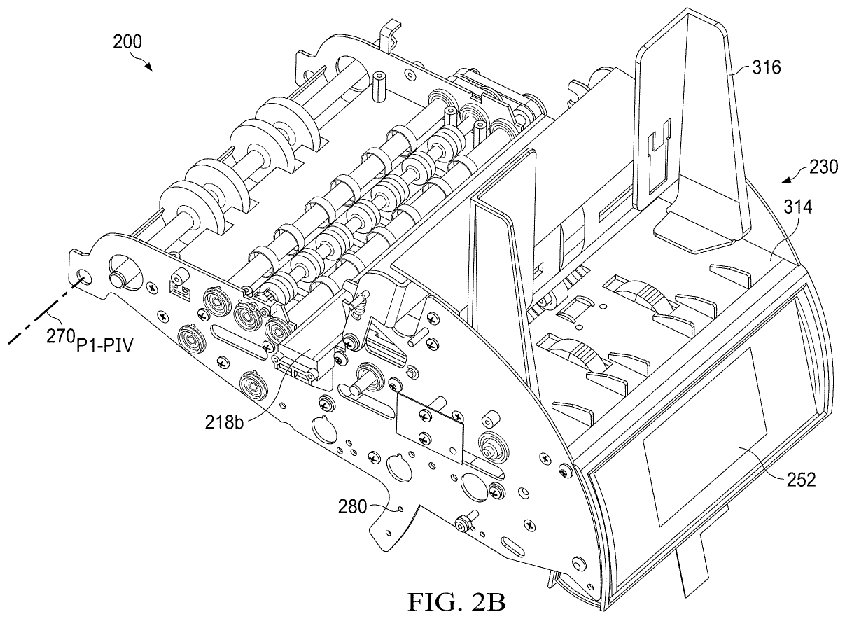

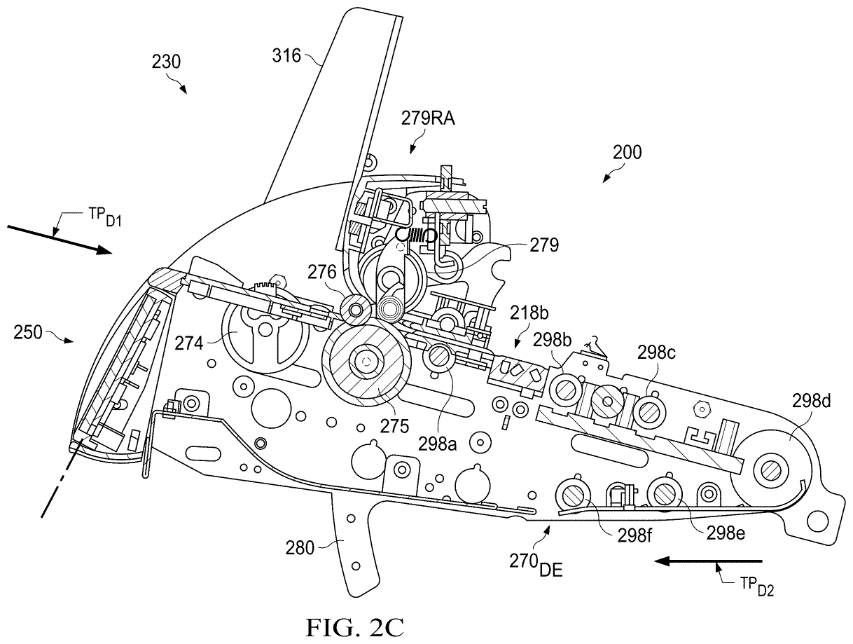

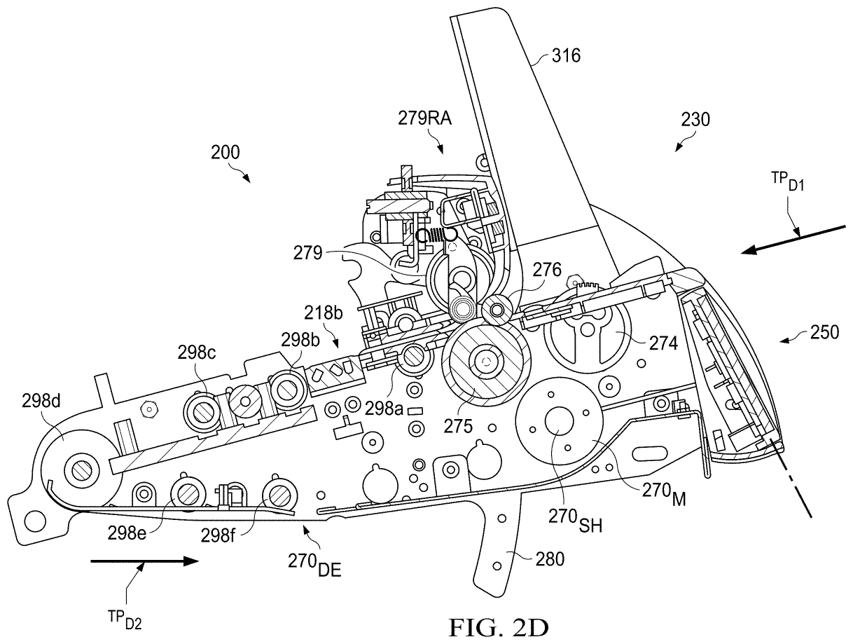

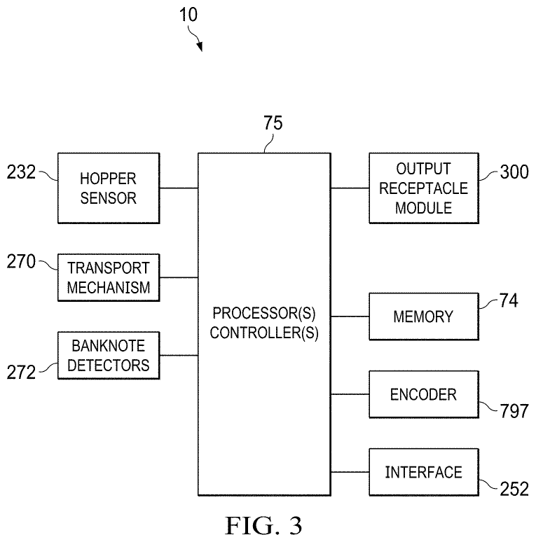

FIGS. 2A-2D illustrate various views of a common input and discrimination module 200 in accordance with various embodiments of this disclosure. FIG. 2A illustrates a first side or right-side perspective view of select components of a common input and discrimination module 200 for a banknote processing device 10 in accordance with various embodiments of this disclosure. FIG. 2B illustrates a second side or left-side perspective view of select components of a common input and discrimination module 200 for a banknote processing device 10 in accordance with various embodiments of this disclosure. FIG. 2C illustrates a right-side view of select components of a common input and discrimination module 200 for a banknote processing device 10 in accordance with various embodiments of this disclosure. FIG. 2D illustrates a left-side view of select components of a common input and discrimination module 200 for a banknote processing device 10 in accordance with various embodiments of this disclosure. Throughout this disclosure, various embodiments of the common input and discrimination module 200 can include components of the common input and discrimination module 200 of FIG. 1 and FIGS. 2A-2D. FIG. 3 illustrates examples of some components of the banknote processing device 10 in accordance with various embodiments of this disclosure.

Referring now to FIGS. 1, 2A-2D, and 3, according to various embodiments of this disclosure, the banknote processing device 10 includes a common input and discrimination module 200. According to some embodiments, the common input and discrimination module 200 includes an input hopper or receptacle 230. According to some embodiments, the common input and discrimination module 200 includes a display assembly 250 which includes a user interface 252. As shown in FIG. 2A, the user interface 252 is mounted near a front side of the common input and discrimination module 200. According to some embodiments, the common input and discrimination module 200 includes a hopper extension guide or bracket 316 and a feeder plate 314.

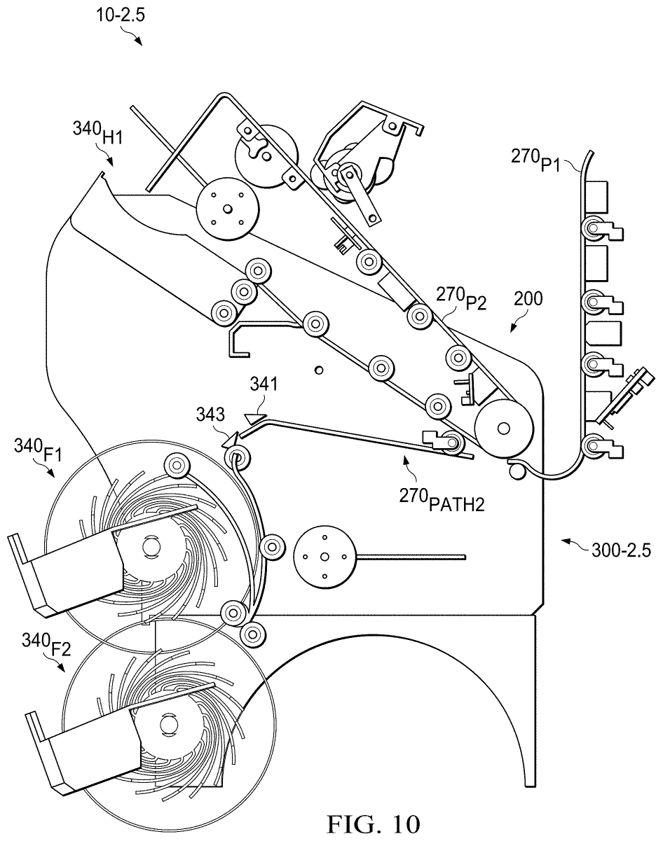

Banknotes or documents to be processed by the banknote processing device 10 are stacked within input hopper 230. A common input and discrimination module transport mechanism 270 then transports the banknotes or documents along a transport path, past one or more sensors or detectors 272, and to an output receptacle module 300. With reference to FIG. 10, according to some embodiments, the banknote processing device 10 includes one or more processors and/or controllers 75 such as a CPU communicatively coupled to a memory 74, one or more hopper sensors 232, electronic components of an output receptacle module 300, components controlling the common input and discrimination module transport mechanism 270 such as one or more motors controlling movement of various driven rollers, the one or more banknote or document sensors or detectors 272, one or more encoders 797, and/or the user or operator interface 252. According to some embodiments, sensors or detectors 272 include one or more denomination sensors, one or more image scanner(s), one or more authentication sensors, one or more density sensors, one or more fitness sensors, or a combination thereof.

The common input and discrimination module 200 includes a common input and discrimination module transport mechanism 270 which may include a driven drive or drum roll 275, passive or idler rollers 610, and/or downstream driven rolls 298 (e.g., 298a-298g, 298a-298f) which transport banknotes residing in input hopper 230 sequentially in a non-overlapping manner along a transport path from the input hopper 230 to an output receptacle module 300. According to some embodiments, the transport mechanism 270 may include stripping or auxiliary wheels 274. According to some embodiments, the transport mechanism may include a retard bracket assembly 279RA including an idler roll 276, retard rollers 279, a pressure roll, and a retard assembly mounting shaft. The driven drive roll 275 and the downstream driven rolls 298 are driven and controlled by one or more motors controlled by the more or more processors 75. For example, as shown in FIGS. 2A and 2D, a transport motor 270_{M} having a drive motor shaft 270_{SH} may rotationally drive shafts on which drum roll 275 and downstream driven rolls 298 are mounted using one or more drive belts 251.

According to some embodiments, the common input and discrimination module 200 includes one or more sensors configured to retrieve information from processed banknotes to denominate the banknotes such as, for example, determining the denomination of U.S. banknotes of a plurality of denominations, and generating a total of the value of a stack or batch of banknotes processed by the banknote processing device 10.

According to some embodiments, the common input and discrimination module 200 includes one or more scanheads configured to optically detect patterns from passing banknotes and determine the denomination of each passing banknote as described in U.S. Pat. No. 5,815,592, incorporated herein by reference in its entirety (see, e.g., scanheads 18a and 18b in FIGS. 24-28, FIGS. 2-5 and 29, and the related description thereof).

According to some embodiments, in place of or in addition to scanheads 18a, 18b described in U.S. Pat. No. 5,815,592, the common input and discrimination module 200 employs a first one-inch wide imaging sensor having a resolution of 288 pixels which employs 288 photosensors instead of the single photodetector found in each of the scanheads 18a, 18b. A second one-inch wide imaging sensor having a resolution of 288 pixels may additionally be employed and be positioned on an opposite side of the transport path in a manner similar to the positioning of scanheads 18a, 18b to enable imaging of a central strip on both sides of a passing banknote. According to some embodiments, the one-inch 288-pixel sensor is more robust and accurate than the half-inch wide scanhead 18a, 18b described in U.S. Pat. No. 5,815,592 that contains only a single photodetector. According to some embodiments, the one-inch 288-pixel sensor provides a low-cost alternative for denominating US currency that is accurate and operates at very high speeds. For example, according to some embodiments, the transport mechanism, the one-inch 288-pixel sensor(s), and the one or more processors 75 transport and denominate U.S. banknotes at rates of at least 600 banknotes per minute, at least 800 banknotes per minute, at least 1000 banknotes per minute, at least 1200 banknotes per minute, and/or at least 1400 banknotes per minute. According to some embodiments, the one-inch 288-pixel sensor improves throughput of the banknote processing device 10 by reducing the number of no-calls and/or the corresponding number of times the transport mechanism 270 must be stopped.

According to some embodiments, the one-inch 288-pixel sensor improves denominating accuracy and provides more data to the one or more processors 75 of the banknote processing device 10 that enables greater resiliency to accommodate changes in new US banknote designs. Additional sensors or detectors 272 such as, for example, authentication sensors may also be employed in the common input and discrimination module 200 or banknote processing device 10.

As shown in FIGS. 1 and 2A-2D, for example, according to some embodiments, instead of or in addition to scanheads 18a, 18b described in U.S. Pat. No. 5,815,592 and/or the one-inch 288-pixel imaging sensor(s) described above, the banknote processing device may employ one or more full-width imaging scanheads 218a, 218b such as those described in U.S. Pat. Nos. 8,401,268, 8,437,530, 8,781,206, and 9,355,295, each incorporated herein by reference in its entirety.

As shown in FIGS. 1, 2C, and 2D, according to some embodiments, the common input and discrimination module 200 has a first transport path section 270_{PATH1} which is defined at least in part by a first transport plate 270_{P1} on one side of the first transport path section 270_{PATH1} and a second transport plate 270_{P2} on an opposing side of the first transport path section 270_{PATH1}. According to some embodiments, the common input and discrimination module banknote transport path turns by at least 90° with respect to an initial transport direction TP_{D1} and in some embodiments turns by at least 135° with respect to an initial transport direction TP_{D1} such that banknotes are transported in a second transport direction TP_{D2}. According to some embodiments, the common input and discrimination module banknote transport path turns by between about 90° and 180° with respect to an initial transport direction TP_{D1}. According to some embodiments, the second transport plate 270_{P2} bends by a corresponding amount to define the turn in the transport direction from being initially in direction TP_{D1} to being in direction TP_{D2}. According to some embodiments, a second transport path section 270_{PATH2} which is defined at least in part by a third transport plate 270_{P3} on one side of the second transport path section 270_{PATH2} and a fourth transport plate 370_{P4} on an opposing side of the second transport path section 270_{PATH2}. Banknotes are transported along the second transport path section 270_{PATH2} in the direction TP_{D2}. According to some embodiments, the second transport plate 270_{P2} and the third transport plate 270_{P3} may be formed from a single, unitary plate or from more than one separate transport plates. As shown in FIGS. 1, 2C, and 2D, the common input and discrimination module banknote transport path has a downstream end 270_{DE}.

According to some embodiments, on an opposing side of the transport path from downstream driven rolls 298a-298g or 298a-298f, there are a plurality of passive or idler rollers 610a-610f which press banknotes passing therebetween into contact with the driven rolls 298a-298f. As shown in FIG. 1, passive or idler rollers 610a-610d2 are illustrated, but, according to some embodiments, there are idler rollers 610 opposite driven rolls 298e-298g as well. Additionally, according to some embodiments, to assist with the change of direction of transport of banknotes around driven transport roll 298d, two or more idler rolls 610d1, 610d2 may be employed. As disclosed in various embodiments of this disclosure, the common input and discrimination module 200 further includes arms 280 disposed on each side of the common input and discrimination module 200 that extend downward and that can abut a surface 380 of the output receptacle module 300 to assist with alignment of the common input and discrimination module 200 when coupled to output receptacle module 300.

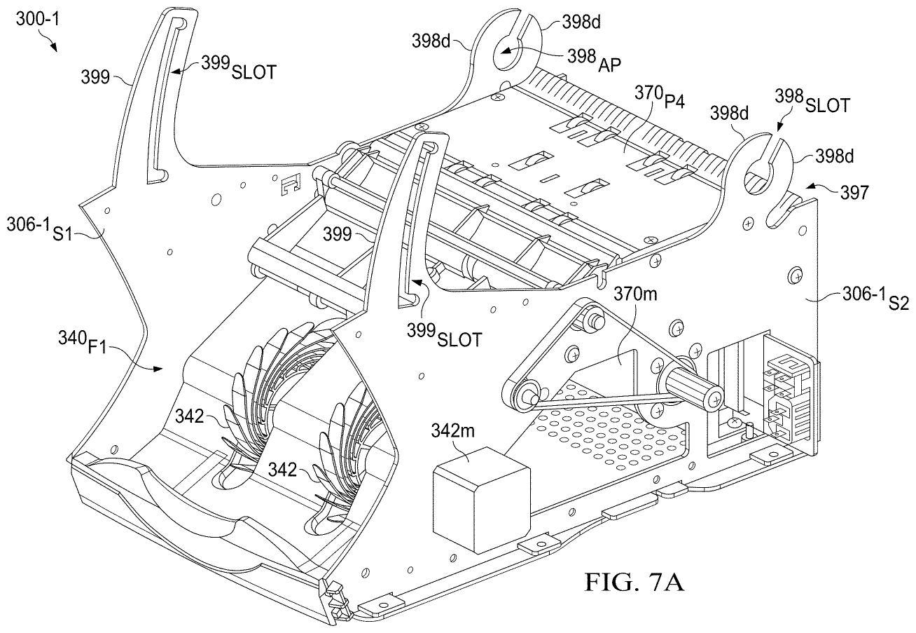

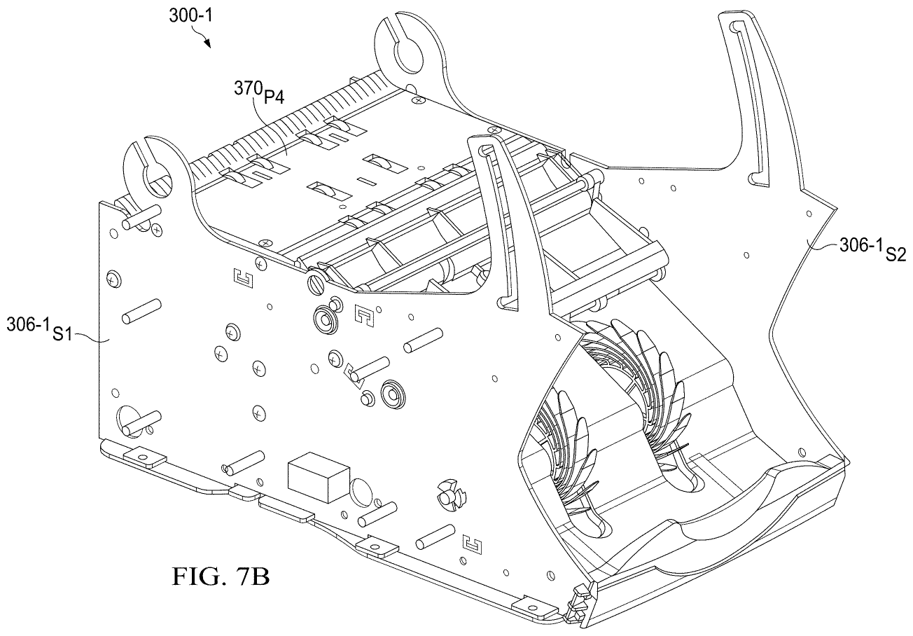

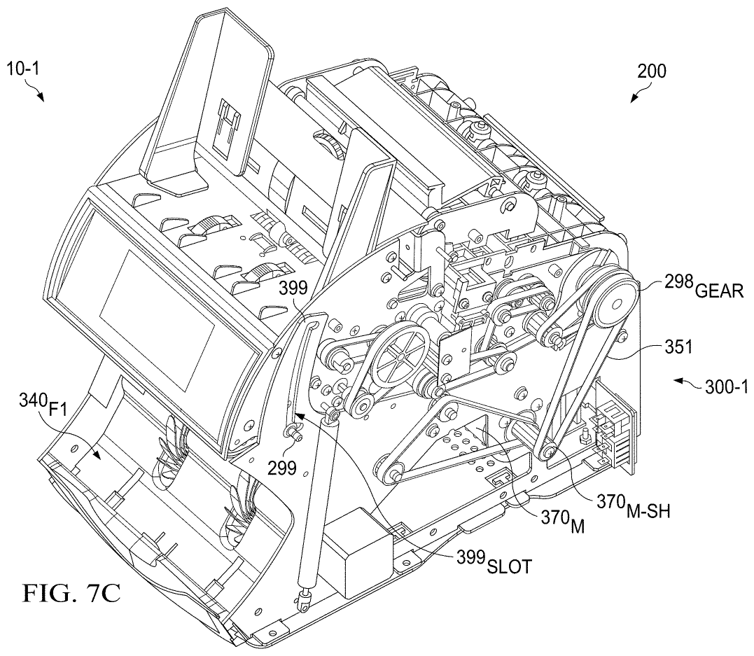

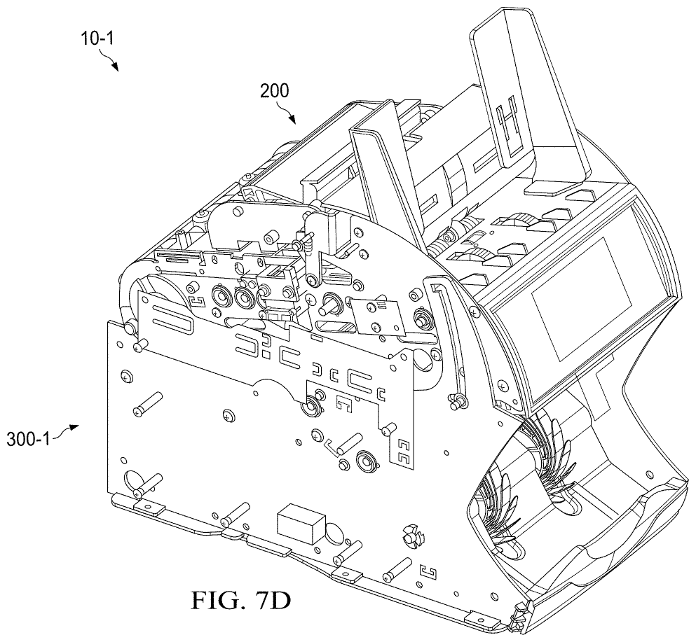

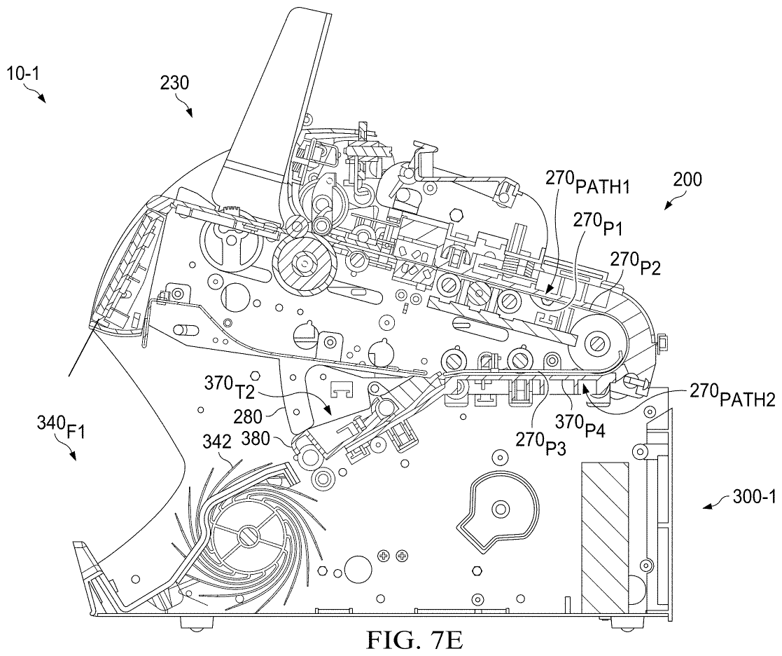

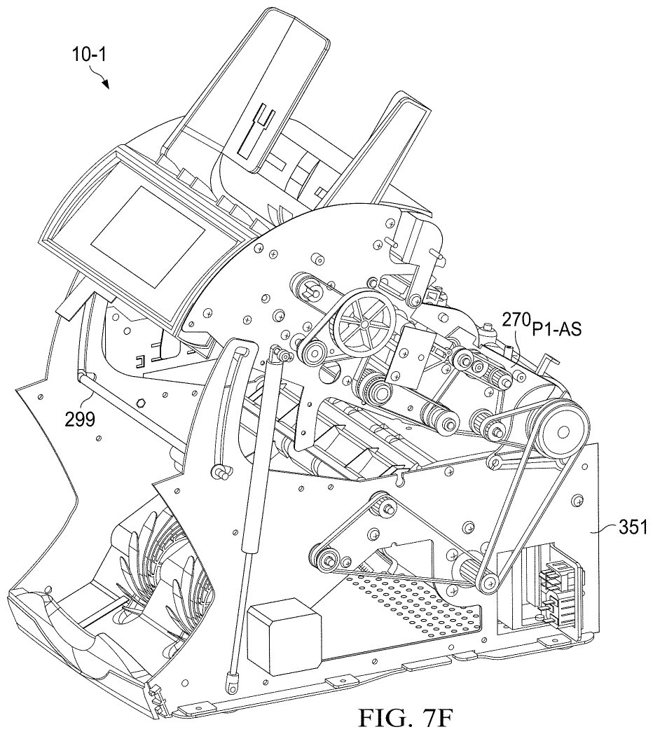

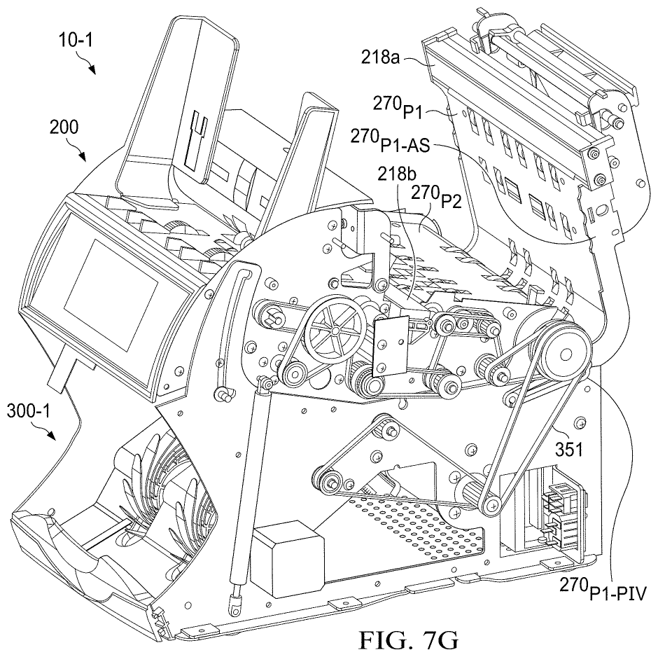

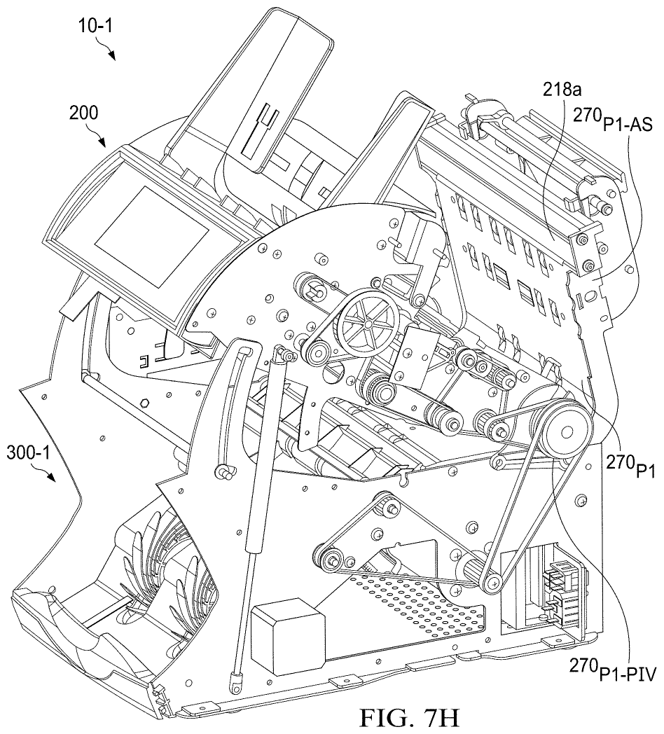

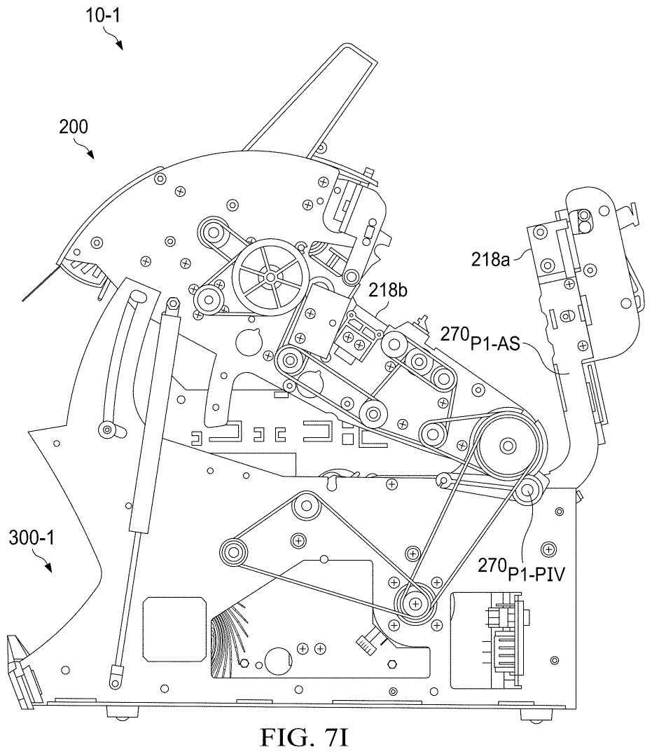

As described in U.S. Patent Application Publication No. 2020/0327763, sometimes the idler rollers 610 need to be replaced as part of maintenance of a banknote processing device such as banknote processing device 10. Idler rollers assemblies 600 and efficient ways to install, remove, assemble, disassemble, and service the idler rollers 610 and idler rollers assemblies 600 are discussed in connection with FIGS. 7A-7I of U.S. Patent Application Publication No. 2020/0327763.

According to some embodiments, common input and discrimination module 200 and the output module 300 have a height of H₁, a depth of D₁, and a width of W₁. According to some embodiments, the depth D₁ is between about 10½ and 12 inches or is less than about 11.1 inches. According to some embodiments, the height H₁ is between about 9 and 11 inches or is less than about 9.7 inches. According to some embodiments, the width W₁ is between about 11 and 13 inches or is less than about 13 inches.

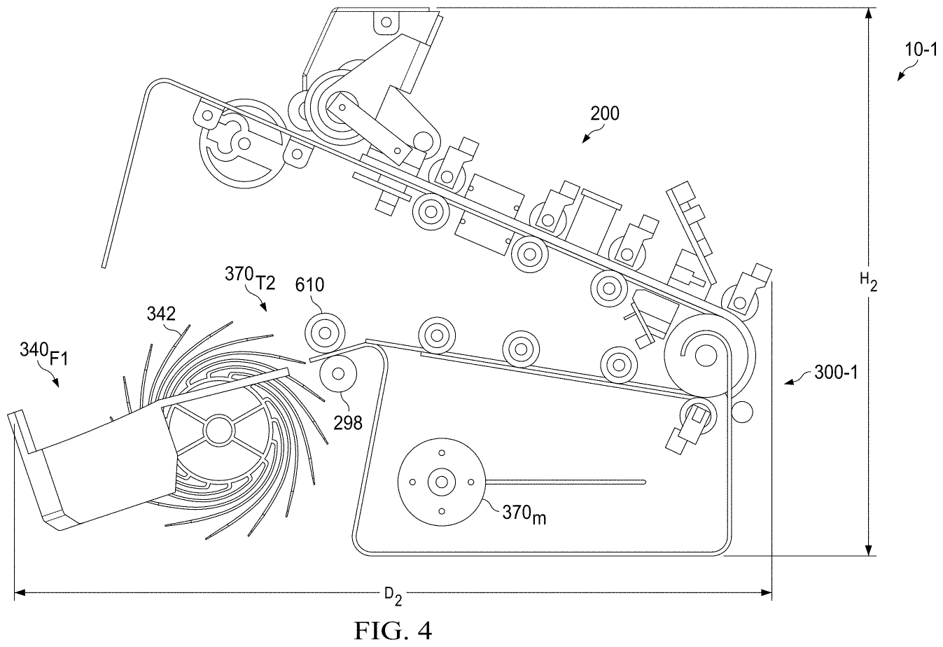

FIG. 4 illustrates a cross-sectional view of select components of a banknote processing device 10-1 including the common input and discrimination module 200 and an output receptacle module 300-1 including a single full output receptacle 340_{F1} in accordance with various embodiments of this disclosure.

According to some embodiments, a full output receptacle 340_{F} receives banknotes from one or more stacking wheels 342. According to some embodiments, a full output receptacle 340_{F} has a capacity of about or at least about 250 banknotes. Banknotes delivered from the downstream end 270_{DE} of the common input and discrimination module banknote transport path are transported by an output receptacle module transport mechanism 370_{T2} to the full output receptacle 340_{F1}. According to some embodiments, the output receptacle module transport mechanism 370_{T2} includes one or more driven transport rolls 298 and idler rollers 610 and stacking wheels 342. The operation of the output receptacle module transport mechanism 370_{T2} may be controlled by one or more processors, such as processor(s) 75, communicatively coupled electronic components associated therewith, such as a transport motor 370_{M} and/or a stacker wheel motor or solenoid 342_{M}, such as shown in FIG. 7A.

According to some embodiments, banknote processing device 10-1 has a height of H₂, a depth of D₂, and a width of W₂. According to some embodiments, the depth D₂ is between about 12½ and 14 inches or is less than about 13.3 inches. According to some embodiments, the height H₂ is between about 9 and 11 inches or is less than about 9.7 inches. According to some embodiments, the width W₂ is between about 11 and 13 inches or is less than about 13 inches.

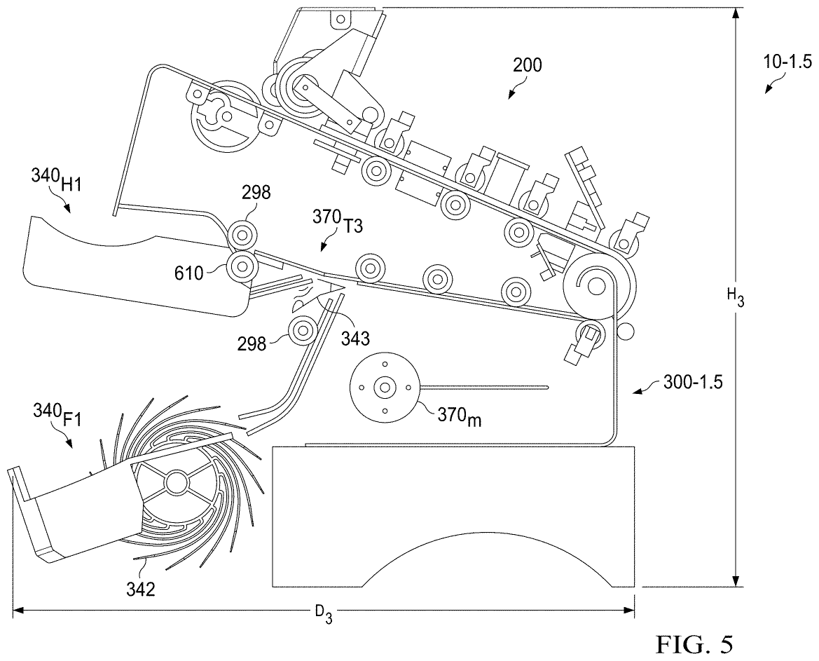

FIG. 5 illustrates a cross-sectional view of select components of a banknote processing device 10-1.5 including the common input and discrimination module 200 and an output receptacle module 300-1.5 including a full output receptacle 340_{F1} and a partial output receptacle 340_{H1} in accordance with various embodiments of this disclosure.

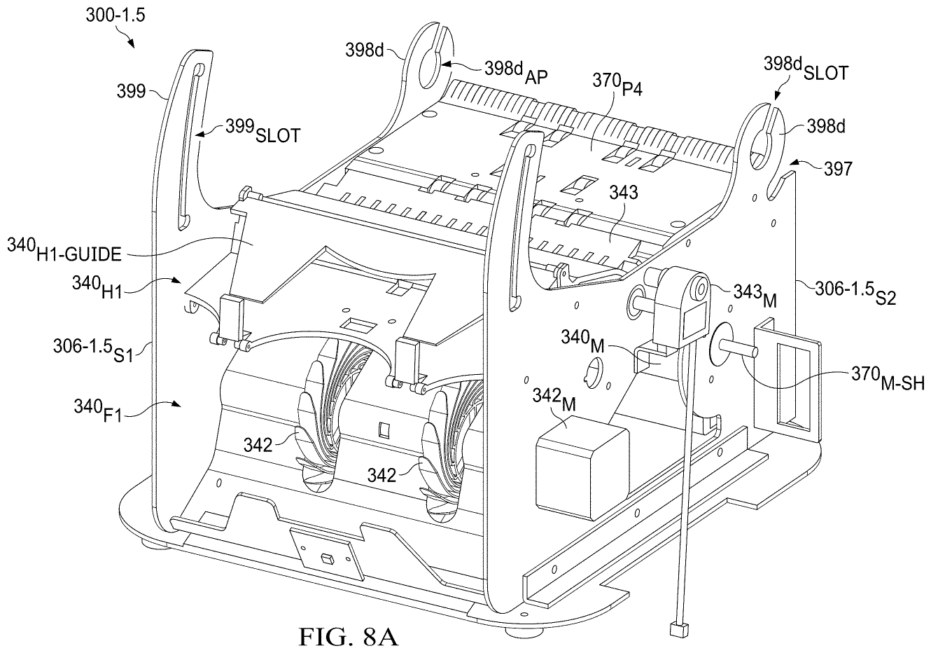

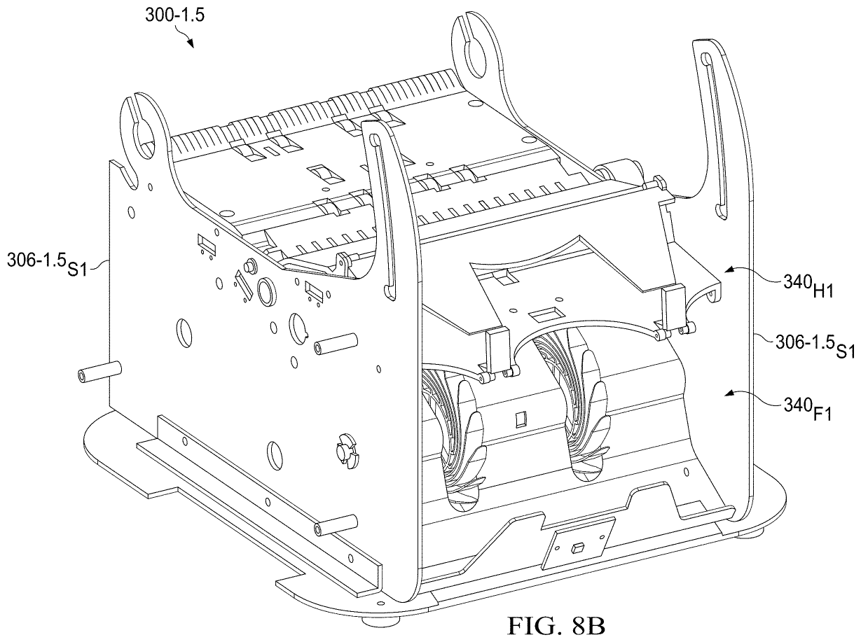

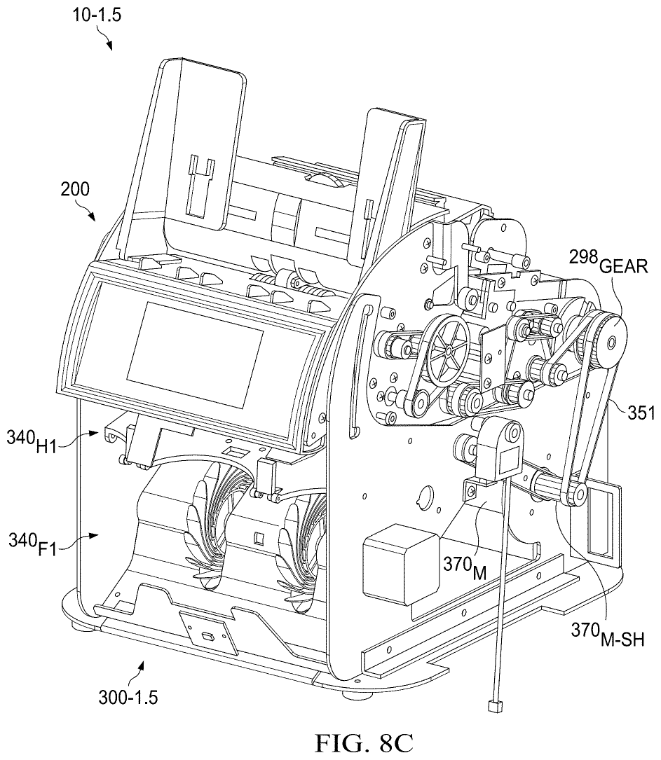

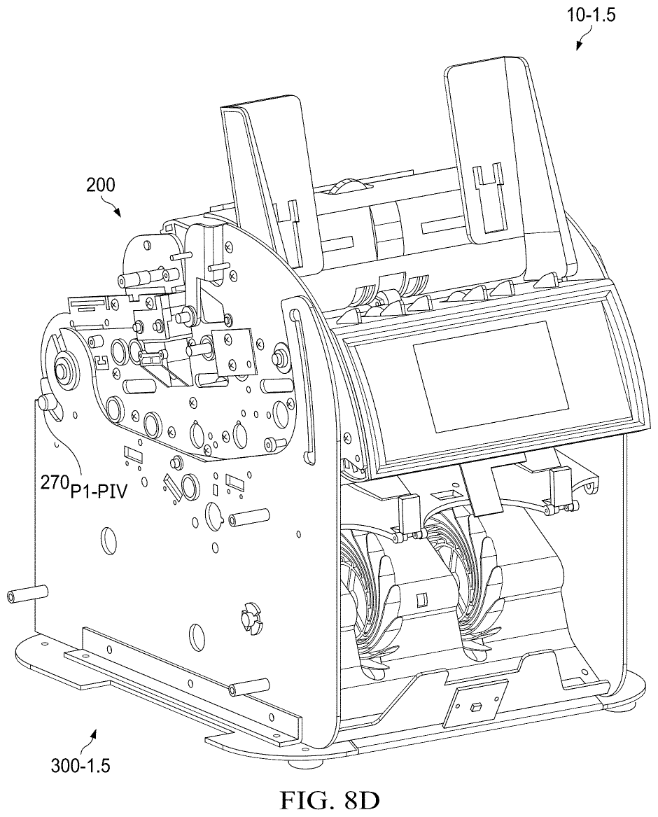

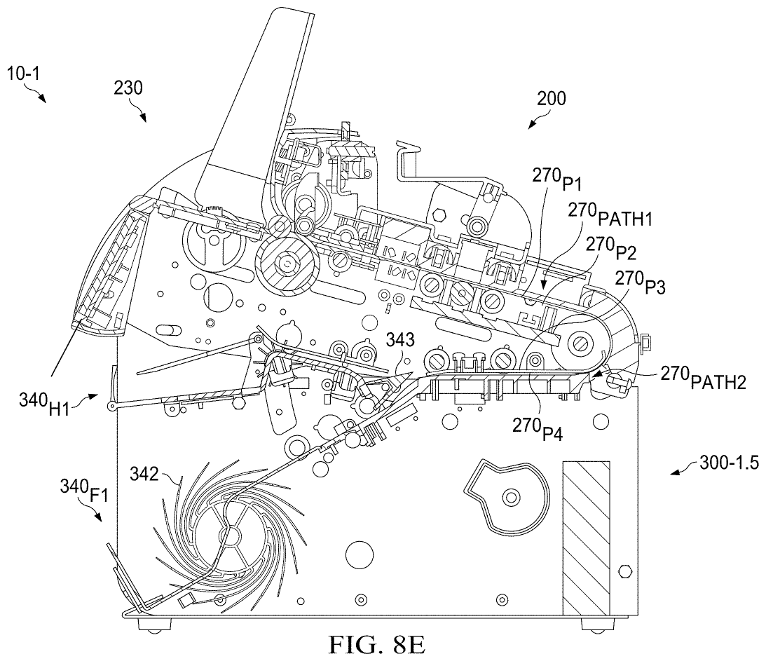

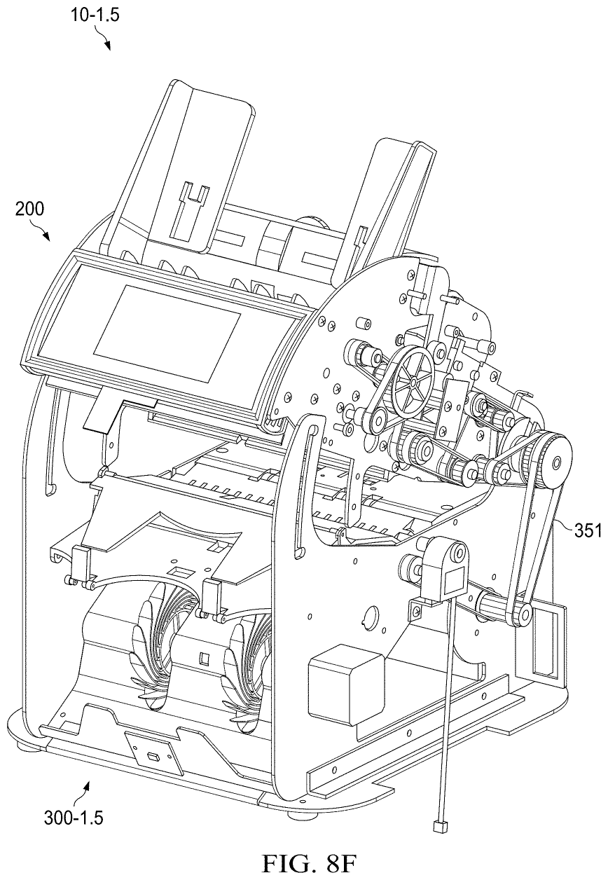

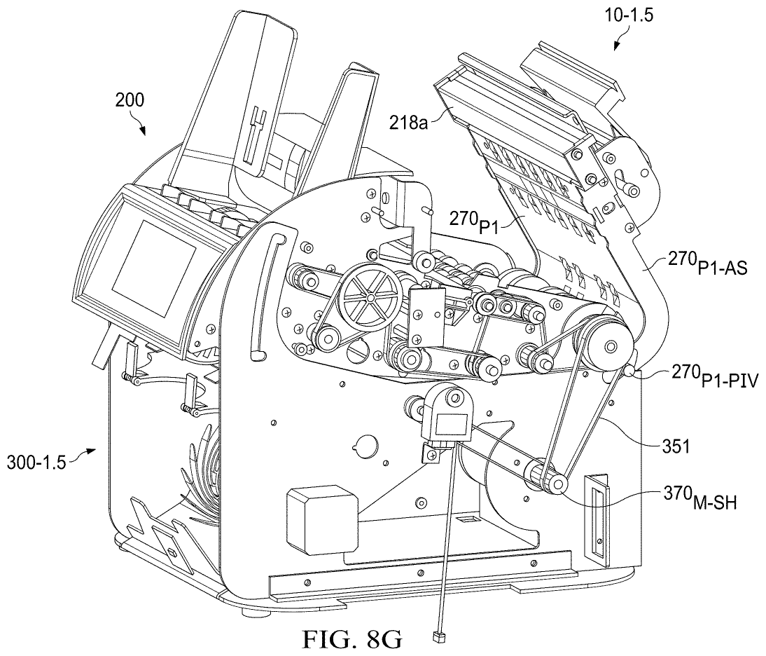

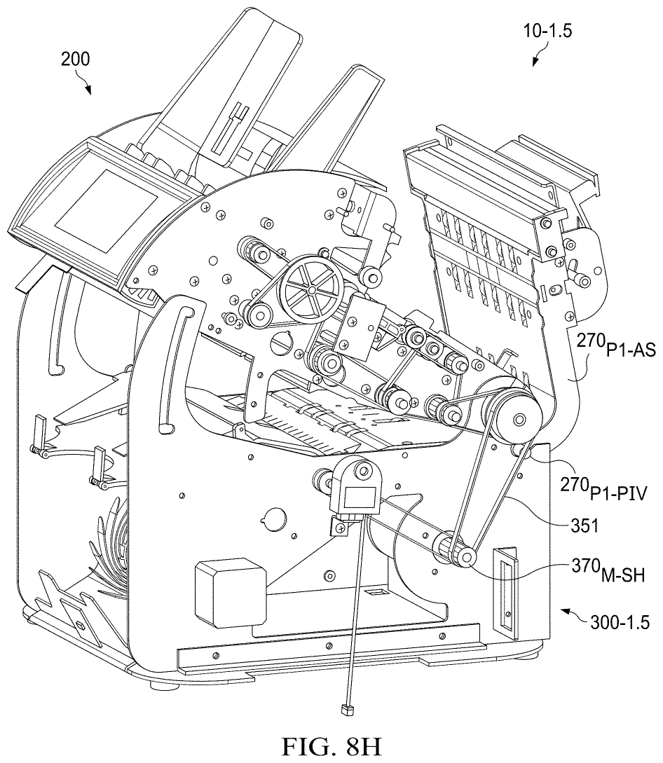

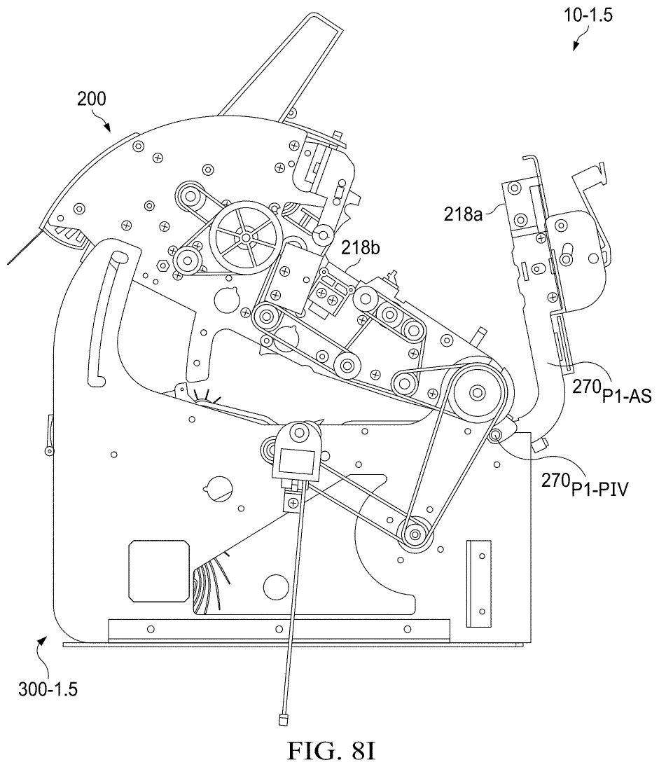

According to some embodiments, a partial or smaller output receptacle 340_{H} does not receive banknotes from one or more stacking wheels 342. According to some embodiments, a partial or smaller output receptacle 340_{H} has a capacity of about or less than about 100 banknotes. Banknotes delivered from the downstream end 270_{DE} of the common input and discrimination module banknote transport path may selectively be transported by an output receptacle module transport mechanism 370_{T3} to the full output receptacle 340_{F1} and/or the partial or smaller output receptacle 340_{H1}. According to some embodiments, the output receptacle module transport mechanism 370_{T3} includes one or more driven transport rolls 298, idler rollers 610, stacking wheels 342, and diverters 343. The operation of the output receptacle module transport mechanism 370_{T3} may be controlled by one or more processors, such as processor(s) 75, communicatively coupled electronic components associated therewith, such as a transport motor 370_{M}, a stacker wheel motor or solenoid 342_{M}, and/or a diverter solenoid 343_{M}, such as shown in FIG. 8A.

According to some embodiments, banknote processing device 10-1.5 has a height of H₃, a depth of D₃, and a width of W₃. According to some embodiments, the depth D₃ is between about 12½ and 14 inches or is less than about 13.7 inches. According to some embodiments, the height H₃ is between about 11½ and 13 inches or is less than about 12.7 inches. According to some embodiments, the width W₃ is between about 11 and 13 inches or is less than about 13 inches.

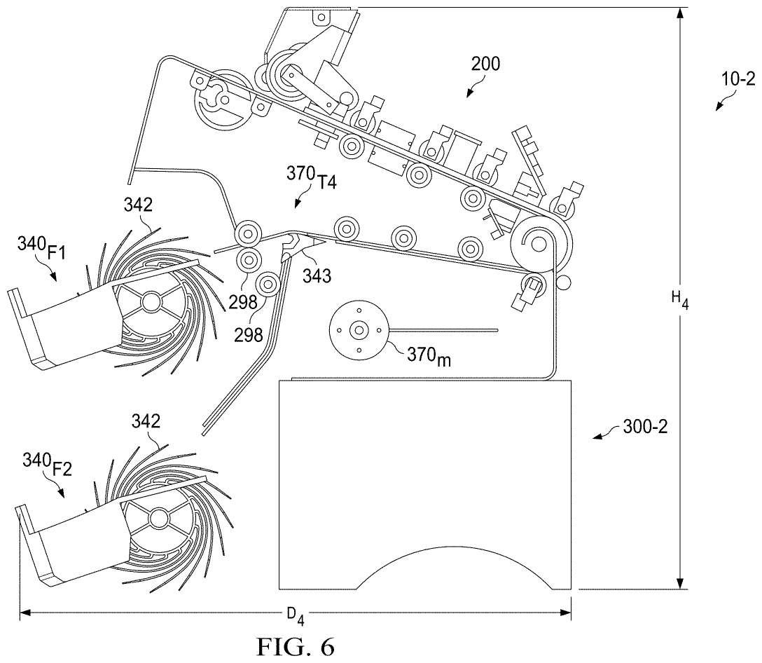

FIG. 6 illustrates a cross-sectional view of select components of a banknote processing device 10-2 including the common input and discrimination module 200 and an output receptacle module 300-2 including two full output receptacles 340_{F1}, 340_{F2} in accordance with various embodiments of this disclosure.

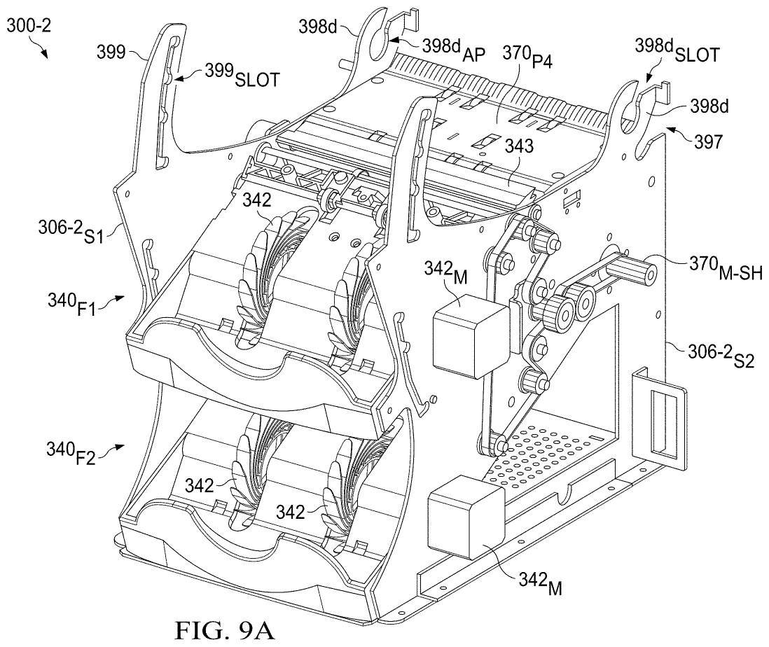

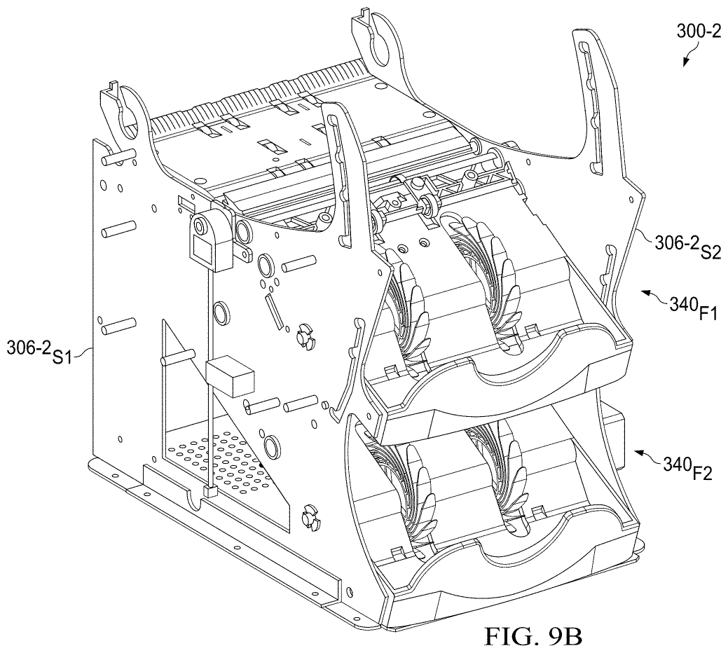

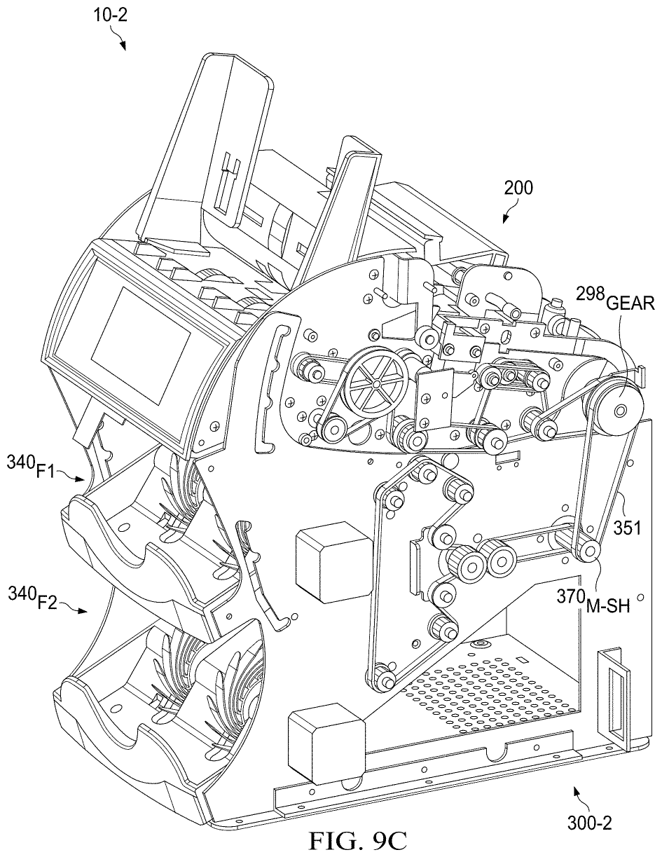

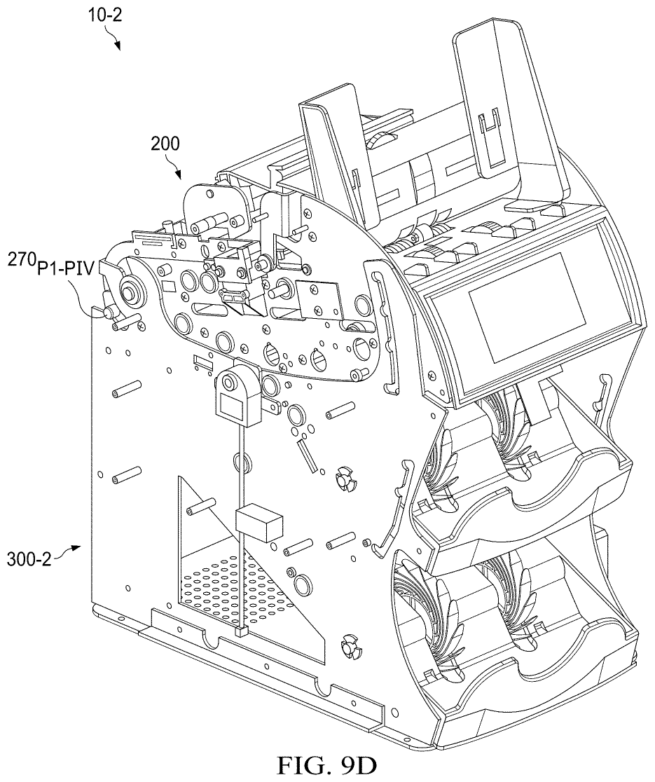

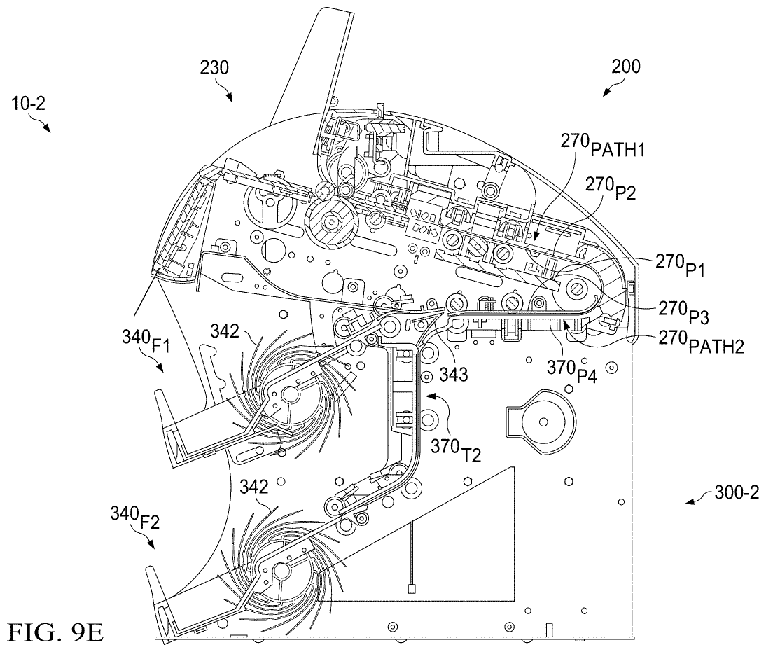

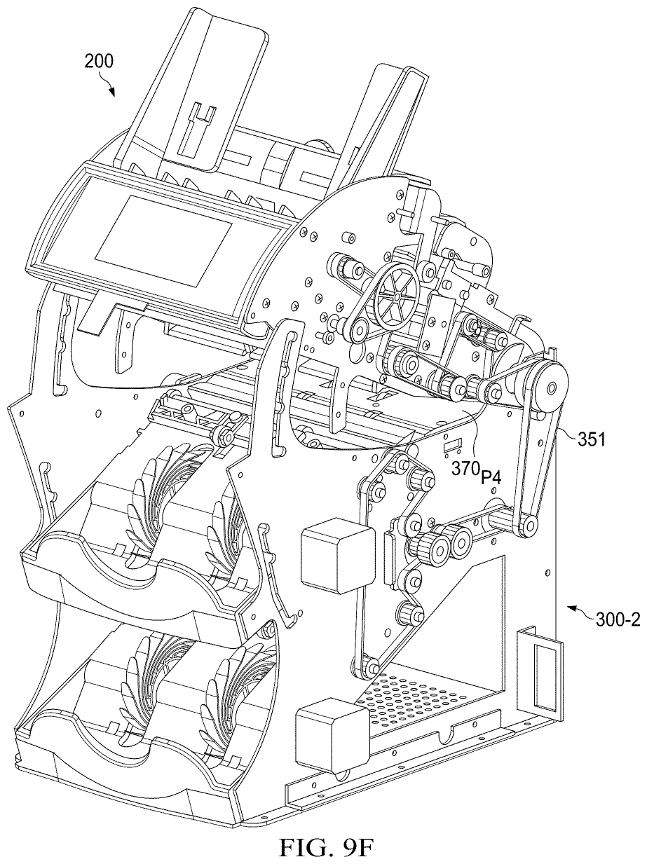

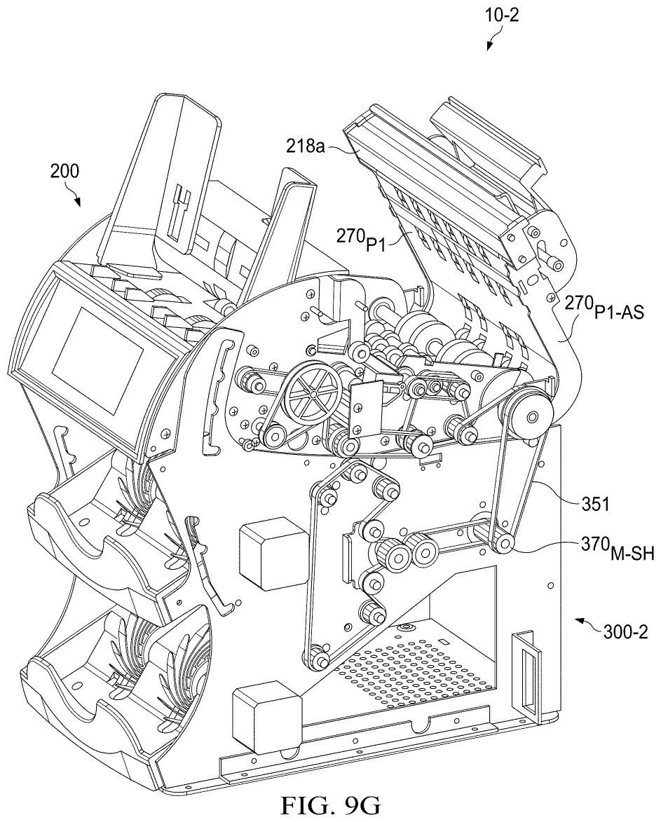

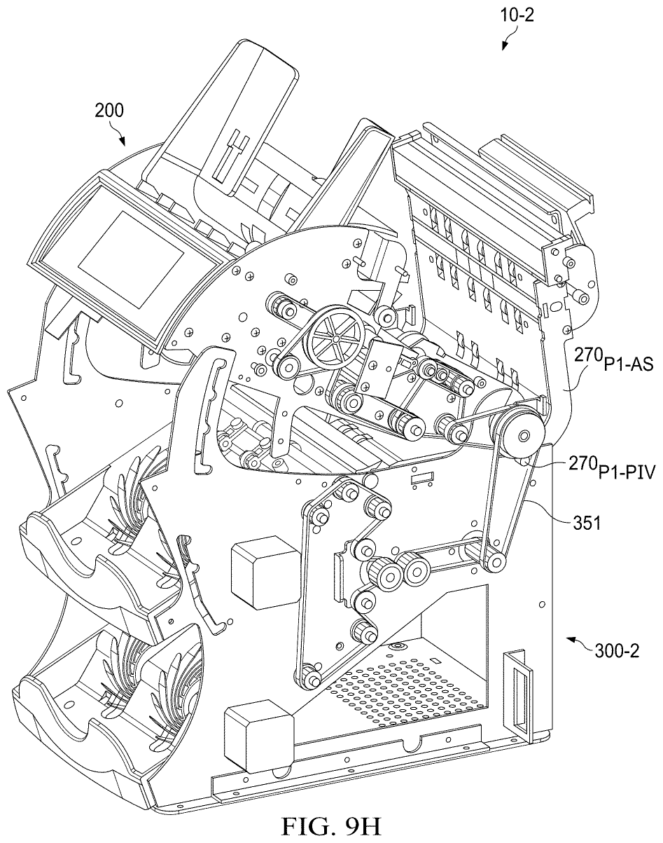

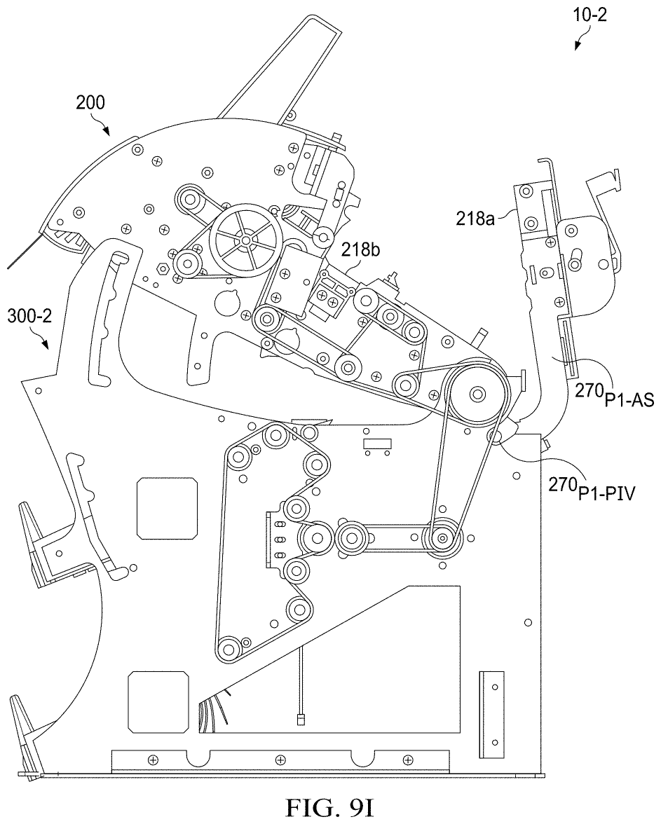

Banknotes delivered from the downstream end 270_{DE} of the common input and discrimination module banknote transport path may selectively be transported by an output receptacle module transport mechanism 370_{T4} to a first full output receptacle 340_{F1} and/or a second full output receptacle 340_{F2}. According to some embodiments, the output receptacle module transport mechanism 370_{T4} includes one or more driven transport rolls 298, idler rollers 610, stacking wheels 342, and diverters 343. The operation of the output receptacle module transport mechanism 370_{T4} may be controlled by one or more processors, such as processor(s) 75, communicatively coupled to electronic components associated therewith, such as a transport motor 370_{M}, a stacker wheel motor or solenoid 342_{M}, and/or a diverter solenoid, such as shown in FIG. 9A.

According to some embodiments, banknote processing device 10-2 has a height of H₄, a depth of D₄, and a width of W₄. According to some embodiments, the depth D₄ is between about 13½ and 15 inches or is less than about 14.2 inches. According to some embodiments, the height H₄ is between about 13½ and 15½ inches or is less than about 14.9 inches. According to some embodiments, the width W₄ is between about 11 and 13 inches or is less than about 13 inches.

FIGS. 7A-7I illustrate various views of an example output receptable module 300-1 in accordance with various embodiments of this disclosure. FIG. 7A illustrates a perspective view of a first side or right-hand side of the output receptable module 300-1 in accordance with various embodiments of this disclosure. FIG. 7B illustrates a perspective view of a second side or left-hand side of the output receptable module 300-1 in accordance with various embodiments of this disclosure. FIG. 7C illustrates a perspective view of a first side or right-hand side of a banknote processing device 10-1 including the output receptacle module 300-1 in an operational condition in accordance with various embodiments of this disclosure. FIG. 7D illustrates a perspective view of a second side or left-hand side of the banknote processing device 10-1 including the output receptacle module 300-1 in the operational condition in accordance with various embodiments of this disclosure. FIG. 7E illustrates a cross-sectional view of the banknote processing device 10-1 including the output receptacle module 300-1 in the operational condition in accordance with various embodiments of this disclosure.

FIG. 7F illustrates a perspective view of the banknote processing device 10-1 in a non-operational condition in accordance with various embodiments of this disclosure. FIG. 7G illustrates a perspective view of the banknote processing device 10-1 in another non-operational condition in accordance with various embodiments of this disclosure. FIG. 7H illustrates a perspective view and FIG. 7I illustrates a side view of the banknote processing device 10-1 in another non-operational condition in accordance with various embodiments of this disclosure.

Referring to FIGS. 7A-7I, the output receptacle module 300-1 includes a single full output receptacle 340_{F1}, such as also shown in FIG. 4. As shown in FIGS. 7C-7I, the output receptacle module 300-1 is configured for use with a common input and discrimination module 200 such as shown in FIGS. 2A-2D. According to some embodiments, the common input and discrimination module 200 is rotatably coupled to the output receptacle module 300-1 such as near a rear portion of each. According to some embodiments, the output receptacle module 300-1 includes a pair of spaced side walls or plates 306-1_{S1}, 306-1_{S2}. Each of the side walls 306-1_{S1}, 306-1_{S2} may have a rear flange 398d having an aperture 398_{AP} therein. Ends of a shaft 298d_{SH} to which the driven roll 298d of the common input and discrimination module 200 is coupled may pass through openings 398_{SLOT} in the rear flanges 398d of the side walls 306_{S1}, 306_{S2} and are seated in the apertures 398_{AP} defined by the rear flanges 398d, such that the shaft 298d_{SH} extends through the apertures 398_{AP} in the rear flanges 398d of the side walls 306-1_{S1}, 306-1_{S2}. This allows the common input and discrimination module 200 to rotate about the shaft 298d_{SH} to permit the common input and discrimination module 200 to rotate with respect to the output receptacle module 300-1 when one side (e.g., a front side) of the common input and discrimination module 200 is raised with respect to the output receptacle module 300-1. This rotation enables the input and discrimination module 200 to move from an operational position shown in FIGS. 7C-7E to a first non-operational position shown in FIG. 7F.

As shown in FIG. 7A-7E, one or more drive belts of the common input and discrimination module 200 may be operatively coupled to a transport motor 370_{M} in an associated output receptacles module 300-1. For example, a drive belt 351 may be coupled between a transport motor shaft 370_{M-SH} of a transport motor 370_{M} in the associated output receptacles module 300-1 and one or more geared pulleys 298_{GEAR} coupled to the drive shaft 298d_{SH} in the common input and discrimination module 200. Other driven transport rollers or wheels in the common input and discrimination module 200 may in turn be operationally coupled to the one or more geared pulleys 298_{GEAR} or the associated drive shaft 298d_{SH}. Thus, according to some embodiments, a common input and discrimination module 200 may be provided without having its own transport motor 270_{M} but instead employs a transport motor 370_{M} residing the output receptacles module 300-1.

When the common input and discrimination module 200 is in the raised first non-operational position, as shown in FIG. 7F, a first transport plate assembly 270_{P1-AS} can be at a closed, operational position. Also, when the common input and discrimination module 200 is in the raised first non-operational position, operator access is provided from the front of the banknote processing device 10-1 to the second transport path section 270_{PATH2} and any banknotes therein between transport plates 270_{P3} and 370_{P4}. To guide the movement of the input and discrimination module 200 between the operational (FIGS. 7C-7E) and the first non-operational (FIG. 7F) positions, the output receptacle module 300-1 includes guide flanges 399, each having an arc-shaped aperture or slot 399_{SLOT} therein and through which guide posts 299 on the sides of the input and discrimination module 200 extend. According to some embodiments, the input and discrimination module 200 may be moved between the operational position shown in FIGS. 7C-7E and the non-operational position shown in FIG. 7F without removing any transport drive belts 351 operatively coupling the transport motor 370_{M} in the output receptacle module 300-1 to the driven transport rollers 298 in the common input and discrimination module 200. For example, transport drive belt 351 may be operatively coupled about a transport motor shaft 370_{M-SH} and drive shaft 298_{SH}, the same shaft about which the common input and discrimination module 200 rotates with respect to the output receptacle module 300-1.

As shown in FIG. 7G the banknote processing device 10-1 is in a second non-operational condition when the first transport plate assembly 270_{P1-AS} is at an open position and with the common input and discrimination module 200 rotated to an operational position with respect to the output receptacle module 300-1. As shown in FIGS. 7H and 7I the banknote processing device 10-1 is in a third non-operational condition when the common input and discrimination module 200 is raised with respect to the output receptacle module 300-1 and when the first transport plate assembly 270_{P1-AS} at an open position.

With reference to FIGS. 7G-7I, ends of a shaft 270_{P1-PIV} to which the first transport plate assembly 270_{P1-AS} is coupled may extend through apertures 397 in the side walls 306-1_{S1}, 306-1_{S2}, as shown in FIGS. 7A and 7D, for example. The first transport plate assembly 270_{P1-AS} rotates about the shaft 270_{P1-PIV} to permit the first transport plate 270_{P1} to rotate with respect to the second transport plate 270_{P2} when the first transport plate 270_{P1} is pivoted about the shaft 270_{P1-PIV} to enable the first transport plate 270_{P1} to move from the operational position shown in FIGS. 7C-7E to the non-operational position shown in FIGS. 7G-7I. When the first transport plate assembly 270_{P1-AS} is in the non-operational position shown in FIGS. 7G-7I, operator access is provided from the front of the banknote processing device 10-1 to the first transport path section 270_{PATH1} and any banknotes therein between transport plates 270_{P1} and 270_{P2}.

As with FIG. 7F, in FIGS. 7H-7I the common input and discrimination module 200 is shown in its raised, non-operational position with respect to the output receptacle module 300-1. In the configuration shown in FIGS. 7H-7I, operator access is provided from the front of the banknote processing device 10-1 to both the first transport path section 270_{PATH1} and any banknotes therein between transport plates 270_{P1} and 270_{P2} and the second transport path section 270_{PATH2} and any banknotes therein between transport plates 270_{P3} and 370_{P4}.

FIGS. 8A-8I illustrate various views of an example output receptacle module 300-1.5 in accordance with various embodiments of this disclosure. FIG. 8A illustrates a perspective view of a first side or right-hand side of the output receptable module 300-1.5 in accordance with various embodiments of this disclosure. FIG. 8B illustrates a perspective view of a second side or left-hand side of the output receptable module 300-1.5 in accordance with various embodiments of this disclosure. FIG. 8C illustrates a perspective view of a first side or right-hand side of a banknote processing device 10-1.5 including the output receptacle module 300-1.5 in an operational condition in accordance with various embodiments of this disclosure. FIG. 8D illustrates a perspective view of a second side or left-hand side of the banknote processing device 10-1.5 including the output receptacle module 300-1.5 in the operational condition in accordance with various embodiments of this disclosure. FIG. 8E illustrates a cross-sectional view of the banknote processing device 10-1.5 including the output receptacle module 300-1.5 in the operational condition in accordance with various embodiments of this disclosure.

FIG. 8F illustrates a perspective view of the banknote processing device 10-1.5 in a non-operational condition in accordance with various embodiments of this disclosure. FIG. 8G illustrates a perspective view of the banknote processing device 10-1.5 in another non-operational condition in accordance with various embodiments of this disclosure. FIG. 8H illustrates a perspective view and FIG. 8I illustrates a side view of the banknote processing device 10-1.5 in another non-operational condition in accordance with various embodiments of this disclosure.

As shown in FIGS. 8A-8I, the output receptacle module 300-1.5 includes a full output receptacle 340_{F1} and a partial or smaller output receptacle 340_{H1}, such as also shown in FIG. 5. As shown in FIGS. 8C-8I, the output receptacle module 300-1.5 is configured for use with a common input and discrimination module 200 such as shown in FIGS. 2A-2D. In general, the output receptacle module 300-1.5 and the banknote processing device 10-1.5 is similar to and operates similarly to the output receptacle module 300-1 and device 10-1, respectively, except for the addition of the partial or smaller output receptacle 340_{H1} and related changes to the transport path such as providing two transport paths leading, respectively, to the full output receptacle 340_{F1} and the partial or smaller output receptacle 340_{H1} and a diverter 343 to selectively direct banknotes to an appropriate one of the output receptacles 340_{F1}, 340_{H1}.

As illustrated, the diverter 343 can include two arms or surfaces that bridge the transport path along one of two subpaths leading to the output receptacles 340_{F1}, 340_{H1} depending on the current rotational position of the diverter 343. In some embodiments, the diverter 343 is coupled to a shaft and operable by a solenoid 343ₘ to move the diverter 343 between a first position and a second position. When in the first position, the diverter 343 diverts banknotes to a first portion of the transport path leading to the partial output receptacle 340_{H1}, and, when in the second position, the diverter diverts banknotes to a second portion of the transport path leading to the full output receptacle 340_{F1}. In some embodiments, the diverter 343 and/or diverter solenoid 343ₘ is controlled by a processor or controller such as the processor(s) 75 disclosed herein. In some embodiments, the diverter 343 is controlled based on a detected or sensed denomination of banknotes, such as, for example, diverting a certain denomination or denominations to one of the output receptacles 340_{F1}, 340_{H1}.

According to some embodiments, the common input and discrimination module 200 is rotatably coupled to the output receptacle module 300-1.5 such as near a rear portion of each. According to some embodiments, the output receptacle module 300-1.5 includes a pair of spaced side walls or plates 306-1.5_{S1}, 306-1.5_{S2}. Each of the side walls 306-1.5_{S1}, 306-1.5_{S2} may have a rear flange 398d having an aperture 398_{AP} therein. Ends of a shaft 298d_{SH} to which driven roll 298d is coupled may pass through openings 398_{SLOT} in the rear flanges 398d of the side walls 306-1.5_{S1}, 306-1.5_{S2} and are seated in the apertures 398_{AP} defined by the rear flanges 398d, such that the shaft 298d_{SH} extends through the apertures 398_{AP} in the rear flanges 398d of the side walls 306-1.5_{S1}, 306-1.5_{S2}. This allows the common input and discrimination module 200 to rotate about the shaft 298d_{SH} to permit the common input and discrimination module 200 to rotate with respect to the output receptacle module 300-1.5 when a front side of the common input and discrimination module 200 is raised or rotated with respect to the output receptacle module 300-1.5. This rotation enables the input and discrimination module 200 to move from the operational position shown in FIGS. 8C-8E to a first non-operational position shown in FIG. 8F. As shown in FIG. 8F, when in the first non-operational position, the first transport plate assembly 270_{P1-AS} at a closed, operational, position.

As shown in FIG. 8A-8E, one or more drive belts of the common input and discrimination module 200 may be operatively coupled to a transport motor 370_{M} in an associated output receptacles module 300-1.5. For example, a drive belt 351 may be coupled between a transport motor shaft 370_{M-SH} of a transport motor 370_{M} in the associated output receptacles module 300-1.5 and one or more geared pulleys 298_{GEAR} coupled to the drive shaft 298d_{SH} in the common input and discrimination module 200. Other driven transport rollers or wheels in the common input and discrimination module 200 may in turn be operationally coupled to the one or more geared pulleys 298_{GEAR} or the associated drive shaft 298d_{SH}. Thus, according to some embodiments, a common input and discrimination module 200 may be provided without having its own transport motor 270_{M} but instead employs a transport motor 370_{M} residing the output receptacles module 300-1.5.

When the common input and discrimination module 200 is in the raised, non-operational position shown in FIG. 8F, operator access is provided from the front of the banknote processing device 10-1.5 to the second transport path section 270_{PATH2} and any banknotes therein between transport plates 270_{P3} and 370_{P4}. To guide the movement of the input and discrimination module 200 between its operational (FIGS. 8C-8E) and its non-operational (FIG. 8F) positions, the output receptacle module 300-1.5 includes guide flanges 399, each having an aperture 399_{SLOT} therein and through which guide posts 299 on the sides of the input and discrimination module 200 extend. According to some embodiments, the partial or smaller output receptacle 340_{H1} includes a guide plate 340_{H1-GUIDE} to aid in directing banknotes into the output receptacle 340_{H1} and/or keeping banknotes directed to the output receptacle 340_{H1} from flying out of the banknote processing device 10-1.5.

As shown in FIG. 8G, the banknote processing device 10-1.5 of FIGS. 8C-8E is in a second non-operational condition when the first transport plate assembly 270_{P1-AS} is at an open position and with the common input and discrimination module 200 rotated to the operational position with respect to the output receptacle module 300-1.5. As shown in FIGS. 8H and 8I the banknote processing device 10-1.5 is in a third non-operational condition when the common input and discrimination module 200 is raised with respect to the output receptacle module 300-1.5 and when the first transport plate assembly 270_{P1-AS} is at an open position.

With reference to FIGS. 8G-8I, ends of a shaft 270_{P1-PIV} to which the first transport plate assembly 270_{P1-AS} is coupled may extend through the apertures 397 in the side walls 306-1.5_{S1}, 306-1.5_{S2}, as shown in FIGS. 8A and 8D, for example. The first transport plate assembly 270_{P1-AS} may rotate about the shaft 270_{P1-PIV} to permit the first transport plate assembly 270_{P1-AS} to rotate with respect to the second transport plate 270_{P2} when the first transport plate 270_{P1} is pivoted about the shaft 270_{P1-PIV} to enable the first transport plate assembly 270_{P1-AS} to move from an operational position shown in FIG. 8C to a non-operational position shown in FIGS. 8G-8I. When the first transport plate 270_{P1} is in the non-operational position shown in FIGS. 8G-8I, operator access is provided from the front of the banknote processing device 10-1.5 to the first transport path section 270_{PATH1} and any banknotes therein between transport plates 270_{P1} and 270_{P2}. As with FIG. 8F, in FIGS. 8H-8I the common input and discrimination module 200 is shown in its raised, non-operational position with respect to the output receptacle module 300-1.5.

FIGS. 9A-9I illustrate various view of an example output receptacle module 300-2 in accordance with various embodiments of this disclosure. FIG. 9A illustrates a perspective view of a first side or right-hand side of the output receptable module 300-2 in accordance with various embodiments of this disclosure. FIG. 9B illustrates a perspective view of a second side or left-hand side of the output receptable module 300-2 in accordance with various embodiments of this disclosure. FIG. 9C illustrates a perspective view of a first side or right-hand side of a banknote processing device 10-2 including the output receptacle module 300-2 in an operational condition in accordance with various embodiments of this disclosure. FIG. 9D illustrates a perspective view of a second side or left-hand side of the banknote processing device 10-2 including the output receptacle module 300-2 in the operational condition in accordance with various embodiments of this disclosure. FIG. 9E illustrates a cross-sectional view of the banknote processing device 10-2 including the output receptacle module 300-2 in the operational condition in accordance with various embodiments of this disclosure.

FIG. 9F illustrates a perspective view of the banknote processing device 10-2 in a non-operational condition in accordance with various embodiments of this disclosure. FIG. 9G illustrates a perspective view of the banknote processing device 10-2 in another non-operational condition in accordance with various embodiments of this disclosure. FIG. 9H illustrates a perspective view and FIG. 9I illustrates a side view of the banknote processing device 10-2 in another non-operational condition in accordance with various embodiments of this disclosure.

As shown in FIGS. 9A-9I, the output receptacle module 300-2 includes two full output receptacles 340_{F1}, 340_{F2}, such as also shown in FIG. 6. As shown in FIGS. 9C-9I, the output receptacle module 300-2 is configured for use with a common input and discrimination module 200 such as shown in FIGS. 2A-2D. In general, the output receptacle module 300-2 and the banknote processing device 10-2 is similar to and operates similarly to the output receptacle modules 300-1 and device 10-1 except for the addition of a second output receptacle 340_{F2} and related changes to the transport path such as providing two transport paths leading, respectively, to the first full output receptacle 340_{F1} and the second full output receptacle 340_{F2} and a diverter 343 to selectively direct banknotes to an appropriate one of the output receptacles 340_{F1}, 340_{F2}.

As illustrated, the diverter 343 can include two arms or surfaces that bridge the transport path along one of two subpaths leading to the output receptacles 340_{F1}, 340_{F2} depending on the current rotational position of the diverter 343. In some embodiments, the banknote processing device 10-2 can further include a diverter solenoid 343ₘ such as shown in FIG. 8A to control position of the diverter 343. In some embodiments, the diverter 343 is coupled to a shaft and operable by the solenoid 343ₘ to move the diverter 343 between a first position and a second position. When in the first position, the diverter 343 diverts banknotes to a first portion of the transport path leading to the full output receptacle 340_{F1}, and, when in the second position, the diverter diverts banknotes to a second portion of the transport path leading to the full output receptacle 340_{F2}. In some embodiments, the diverter 343 or the diverter solenoid is further controlled by a processor or controller such as the processor(s) 75 disclosed herein. In some embodiments, the diverter 343 is controlled based on a detected or sensed denomination of banknotes, such as, for example, diverting a certain denomination or denominations to one of the output receptacles 340_{F1}, 340_{F2}.

According to some embodiments, the common input and discrimination module 200 is rotatably coupled to the output receptacle module 300-2 such as near a rear portion of each. According to some embodiments, the output receptacle module 300-2 includes a pair of spaced side walls or plates 306-2_{S1}, 306-2_{S2}. Each of the side walls 306-2_{S1}, 306-2_{S2} may have a rear flange 398d having an aperture 398_{AP} therein. Ends of a shaft 298d_{SH} to which the driven roll 298d is coupled may pass through openings 398_{SLOT} in the rear flanges 398d of the side walls 306-2_{S1}, 306-2_{S2} and are seated in the apertures 398_{AP} defined by the rear flanges 398d, such that the shaft 298d_{SH} extends through the apertures 398_{AP} in the rear flanges 398d of the side walls 306-2_{S1}, 306-2_{S2}. This allows the common input and discrimination module 200 to rotate about the shaft 298d_{SH} to permit the common input and discrimination module 200 to rotate with respect to the output receptacle module 300-2 when a front side of the common input and discrimination module 200 is raised with respect to the output receptacle module 300-2 to enable the input and discrimination module 200. This rotation enables the common input and discrimination module 200 to move from the operational position shown in FIGS. 9C-9E to a first non-operational position shown in FIG. 9F.

As shown in FIG. 9A-9E, one or more drive belts of the common input and discrimination module 200 may be operatively coupled to a transport motor 370_{M} in an associated output receptacles module 300-2. For example, a drive belt 351 may be coupled between a transport motor shaft 370_{M-SH} of a transport motor 370_{M} in the associated output receptacles module 300-2 and one or more geared pulleys 298_{GEAR} coupled to the drive shaft 298d_{SH} in the common input and discrimination module 200. Other driven transport rollers or wheels in the common input and discrimination module 200 may in turn be operationally coupled to the one or more geared pulleys 298_{GEAR} or the associated drive shaft 298d_{SH}. Thus, according to some embodiments, a common input and discrimination module 200 may be provided without having its own transport motor 270_{M} but instead employs a transport motor 370_{M} residing the output receptacles module 300-2.

When the common input and discrimination module 200 is in the raised, non-operational position shown in FIG. 9F, operator access is provided from the front of the banknote processing device 10-2 to the second transport path section 270_{PATH2} and any banknotes therein between transport plates 270_{P3} and 370_{P4}. As shown in FIG. 9F, when in the first non-operational position, the first transport plate assembly 270_{P1-AS} at a closed, operational, position. To guide the movement of the input and discrimination module 200 between the operational (FIGS. 9C-9E) and the first non-operational (FIG. 9F) positions, the output receptacle module 300-2 includes guide flanges 399, each having an aperture 399_{SLOT} therein and through which guide posts 299 on the sides of the input and discrimination module 200 extend.

As shown in FIG. 9G, the banknote processing device 10-2 of FIGS. 9C-9E is in a second non-operational condition when the first transport plate assembly 270_{P1-AS} is at an open position and with the common input and discrimination module 200 rotated to the operational position with respect to the output receptacle module 300-2. As shown in FIGS. 9H and 9I, the banknote processing device 10-2 is in a third non-operational condition when the common input and discrimination module 200 is raised with respect to the output receptacle module 300-1.5 and when the first transport plate assembly 270_{P1-AS} is at an open position.

With reference to FIGS. 9G-9I, ends of a shaft 270_{P1-PIV} to which the first transport plate assembly 270_{P1-AS} is coupled may extend through the apertures 397 in the side walls 306-2_{S1}, 306-2_{S2}, as shown in FIGS. 9A and 9D, for example. The first transport plate assembly 270_{P1-AS} may rotate about the shaft 270_{P1-PIV} to permit the first transport plate assembly 270_{P1-AS} to rotate with respect to the second transport plate 270_{P2} when the first transport plate 270_{P1} is pivoted about the shaft 270_{P1-PIV} to enable the first transport plate assembly 270_{P1-AS} to move from an operational position shown in FIG. 9C to a non-operational position shown in FIGS. 9G-9I. When the first transport plate 270_{P1} is in the non-operational position shown in FIGS. 9G-9I, operator access is provided from the front of the banknote processing device 10-2 to the first transport path section 270_{PATH1} and any banknotes therein between transport plates 270_{P1} and 270_{P2}. As with FIG. 9F, in FIGS. 9H-9I the common input and discrimination module 200 is shown in its raised, non-operational position with respect to the output receptacle module 300-2.

FIG. 10 is a side sectional view of select components of a banknote processing device 10-2.5 in accordance with various embodiments of this disclosure. The banknote processing device 10-2.5 includes the common input and discrimination module 200 and an output receptacle module 300-2.5 having two full output receptacles 340_{F1}, 340_{F2} and one partial output receptacle 340_{H1}. As shown in FIG. 10, the first transport plate 270_{P1} is at an open, non-operational position according to various embodiments of this disclosure.

The output receptacle module 300-2.5 and the banknote processing device 10-2.5 is similar to and operates similarly to the output receptacle module 300-1, 300-1.5, 300-2 and devices 10-1, 10-1.5, and 10-2, respectively, except for the inclusion of both the partial or smaller output receptacle 340_{H1} and two full output receptacles 340_{F1}, 340_{F2} and related changes to the transport path such as providing three transport paths leading, respectively, to the partial output receptacle 340_{H1}, to the full output receptacle 340_{F1}, and to the other full output receptacle 340_{F2}. A first diverter 341 is included to selectively direct banknotes to either the partial output receptacle 340_{H1} or further along the path to a second diverter 343. The second diverter 343 selectively directs banknotes to one of the full output receptacles 340_{F1}, 340_{F2}. It will be understood that the first diverter 341 and the second diverter 343 can include similar structure and can be controlled in a similar manner to the diverters described with respect to FIGS. 8A-8I and FIGS. 9A-9I.

Although not all shown, it will be understood that the banknote processing device 10-2.5 can include similar components as the banknote processing devices 10-1, 10-1.5, 10-2. For example, the output receptacle module 300-2.5 can include the pair of spaced side walls or plates 306-1_{S1}, 306-1_{S2} having the rear flanges 398d and guide flanges 399 for connecting the common input and discrimination module 200 to the output receptacle module 300-2.5, as described with respect to FIGS. 7A-9I. As such, the common input and discrimination module 200 can be rotated with respect to the output receptacle module 300-2.5 when a front side of the common input and discrimination module 200 is raised or rotated with respect to the output receptacle module 300-2.5. This rotation enables the input and discrimination module 200 to move from an operational position to a non-operational position. It will be understood based on this disclosure that the common input and discrimination module 200 can be releasably coupled to any one of the output receptacles modules 300 (e.g., 300-1, 300-1.5, 300-2, 300-2.5).

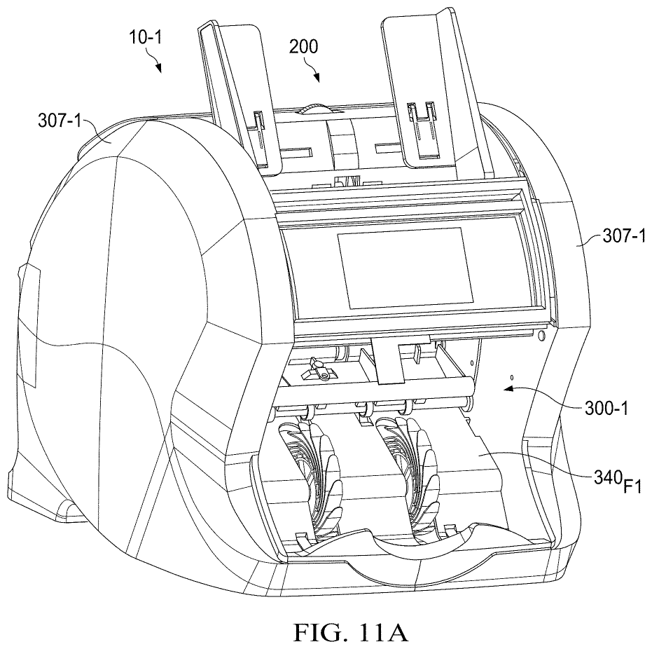

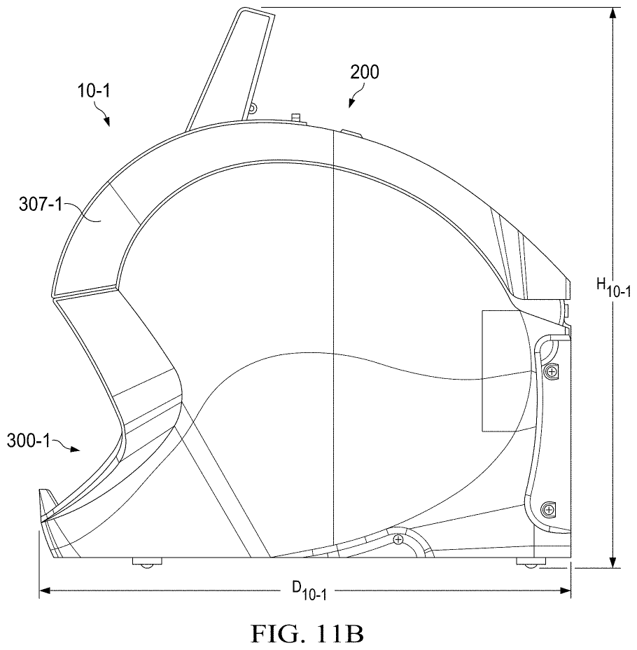

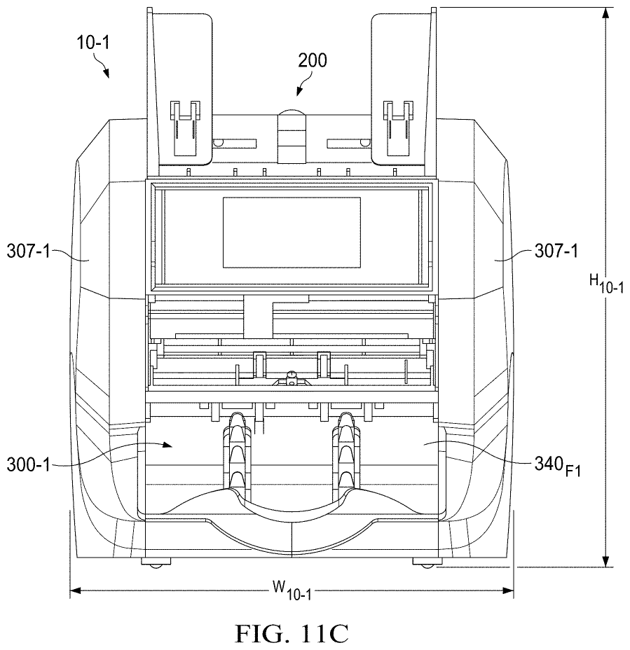

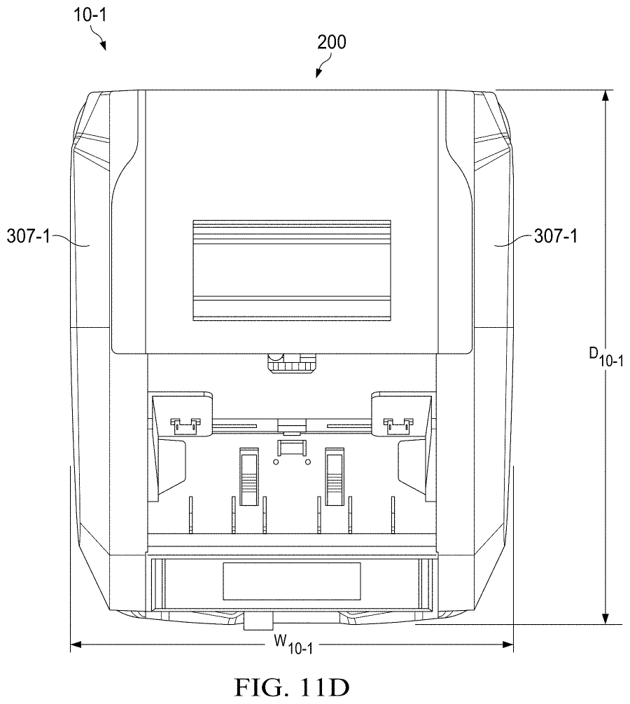

FIGS. 11A-11D illustrate various views of an example banknote processing device 10-1 in accordance with various embodiments of this disclosure. FIG. 11A illustrates a perspective view of the banknote processing device 10-1 in accordance with various embodiments of this disclosure. FIG. 11B illustrates a side view of the banknote processing device 10-1 in accordance with various embodiments of this disclosure. FIG. 11C illustrates a front view of the banknote processing device 10-1 in accordance with various embodiments of this disclosure. FIG. 11D illustrates a top view of the banknote processing device 10-1 in accordance with various embodiments of this disclosure.

In some embodiments, the banknote processing device 10-1 illustrated in FIGS. 11A-11D includes the device 10-1 shown in FIG. 4 and/or FIGS. 7C-7I, including a common input and discrimination module 200 and an output receptacle module 300-1 having a single full output receptacle 340_{F1}. FIGS. 11A-11D show the banknote processing device 10-1 in an operational condition with a first and second side cover 307-1 coupled on a first side and a second side of the banknote processing device 10-1, respectively. According to some embodiments, the device 10-1 has a height H₁₀₋₁ of about or less than about 15.6 inches, a width W₁₀₋₁ of about or less than about 12.4 inches, and a depth D₁₀₋₁ of about or less than about 14.9 inches, a footprint of about or less than about 185 square inches (1.29 square feet), and a volume about or less than about 2852 cubic inches (1.65 cubic feet). According to some embodiments, the device 10-1 has a height H₁₀₋₁ of about or less than about 16 inches, a width W₁₀₋₁ of about or less than about 13 inches, and a depth D₁₀₋₁ of about or less than about 15 inches, a footprint of about or less than about 195 square inches (1.35 square feet), and a volume about or less than about 3120 cubic inches (1.8 cubic feet).

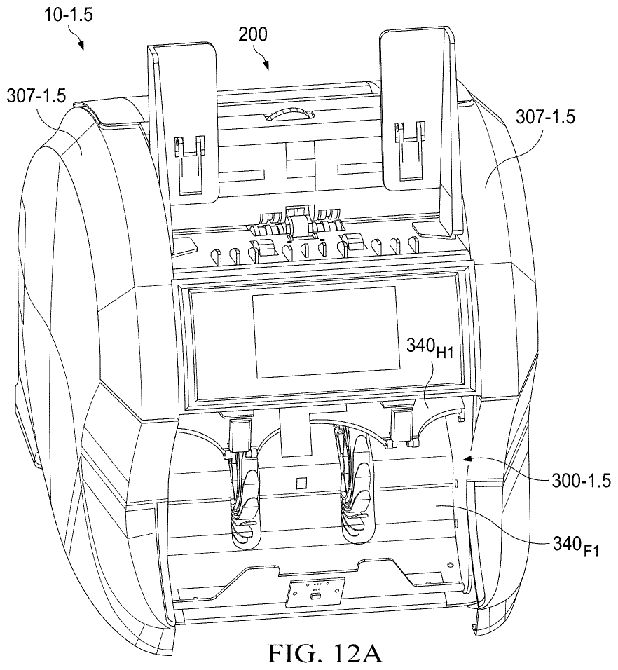

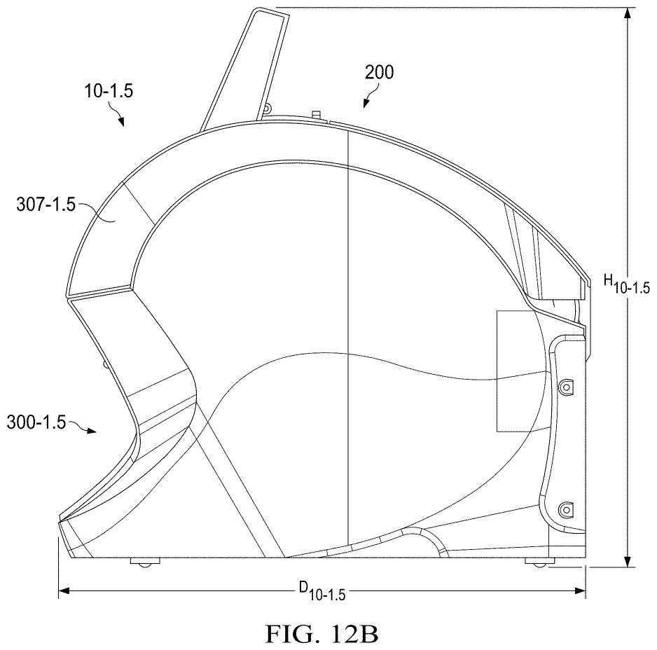

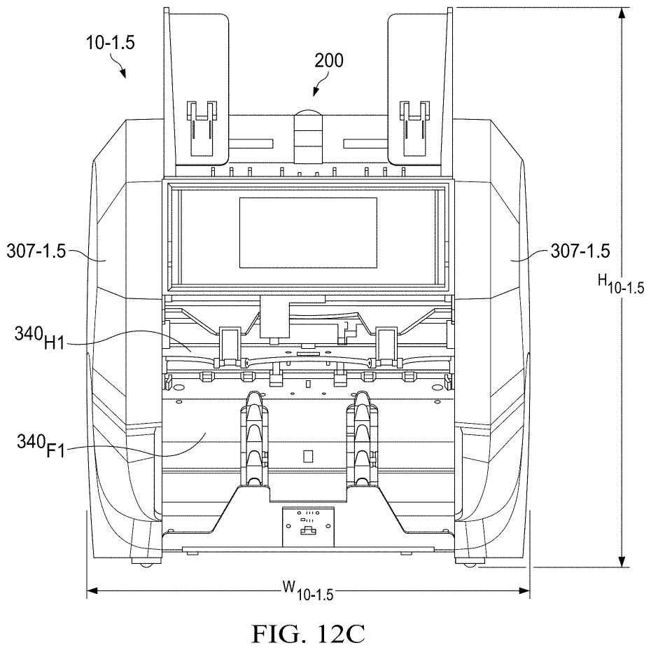

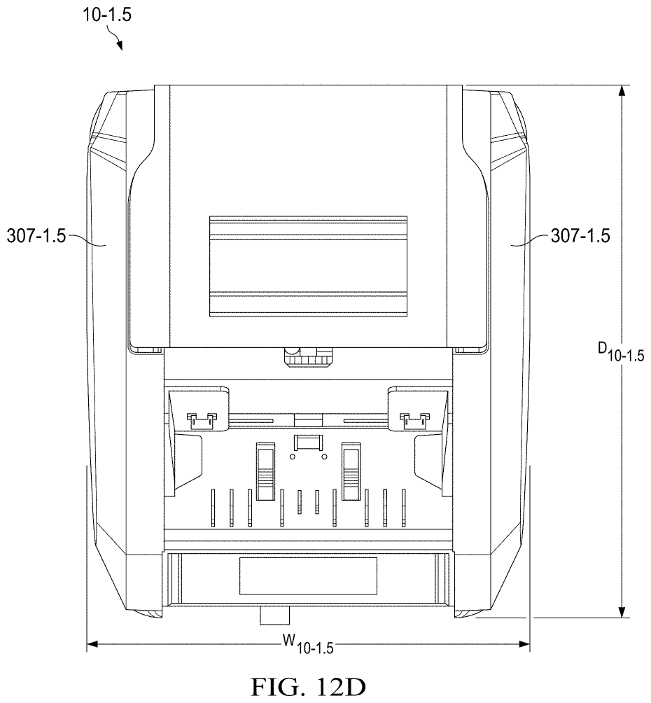

FIGS. 12A-12D illustrate various views of an example banknote processing device 10-1.5 in accordance with various embodiments of this disclosure. FIG. 12A illustrates a perspective view of the banknote processing device 10-1.5 in accordance with various embodiments of this disclosure. FIG. 12B illustrates a side view of the banknote processing device 10-1.5 in accordance with various embodiments of this disclosure. FIG. 12C illustrates a front view of the banknote processing device 10-1.5 in accordance with various embodiments of this disclosure. FIG. 12D illustrates a top view of the banknote processing device 10-1.5 in accordance with various embodiments of this disclosure.

In some embodiments, the banknote processing device 10-1.5 illustrated in FIGS. 12A-12D includes the device 10-1.5 shown in FIG. 5 and/or FIGS. 8C-8I, including a common input and discrimination module 200 and an output receptacle module 300-1.5 having a full output receptacle 340_{F1} and a partial or smaller output receptacle 340_{H1}. FIGS. 12A-12D show the banknote processing device 10-1.5 in an operational condition with a first and second side cover 307-1.5 coupled on a first side and a second side of the banknote processing device 10-1.5, respectively. According to some embodiments, the device 10-1.5 has a height H_{10-1.5} of about or less than about 16 inches, a width W_{10-1.5} of about or less than about 13 inches, and a depth D_{10-1.5} of about or less than about 15 inches, a footprint of about or less than about 195 square inches (1.35 square feet), and a volume about or less than about 3120 cubic inches (1.8 cubic feet). According to some embodiments, the device 10-1.5 has a height H_{10-1.5} of about or less than about 15.2 inches, a width W_{10-1.5} of about or less than about 12.3 inches, and a depth D_{10-1.5} of about or less than about 14.9 inches, a footprint of about or less than about 183 square inches (1.27 square feet), and a volume about or less than about 2786 cubic inches (1.61 cubic feet).

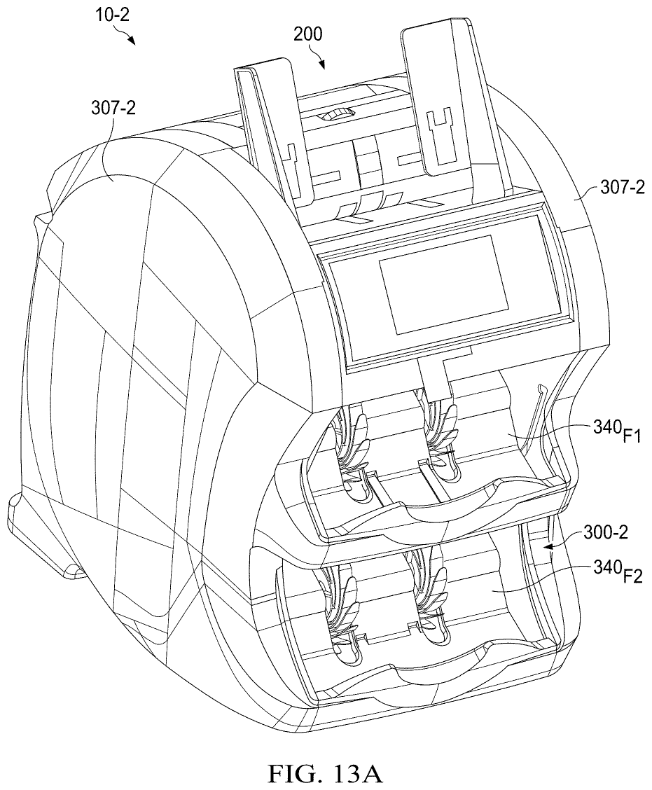

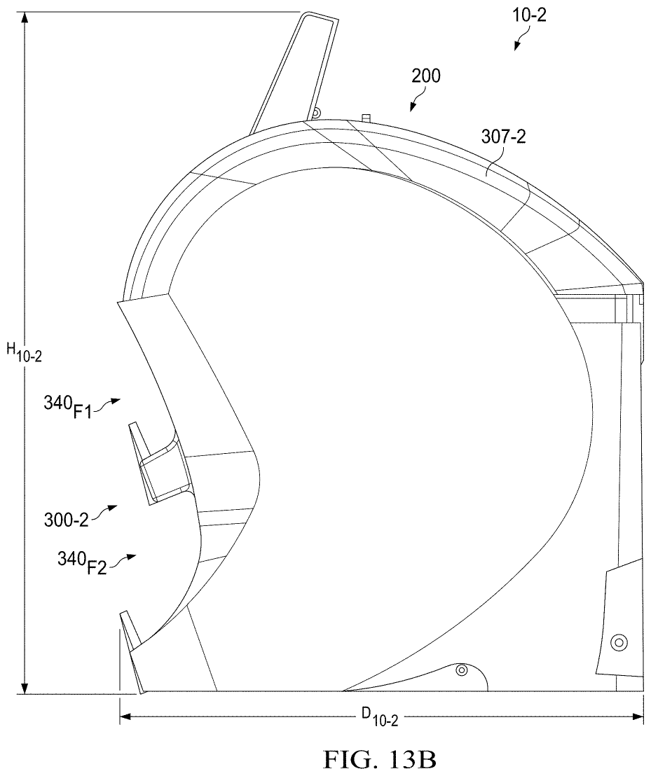

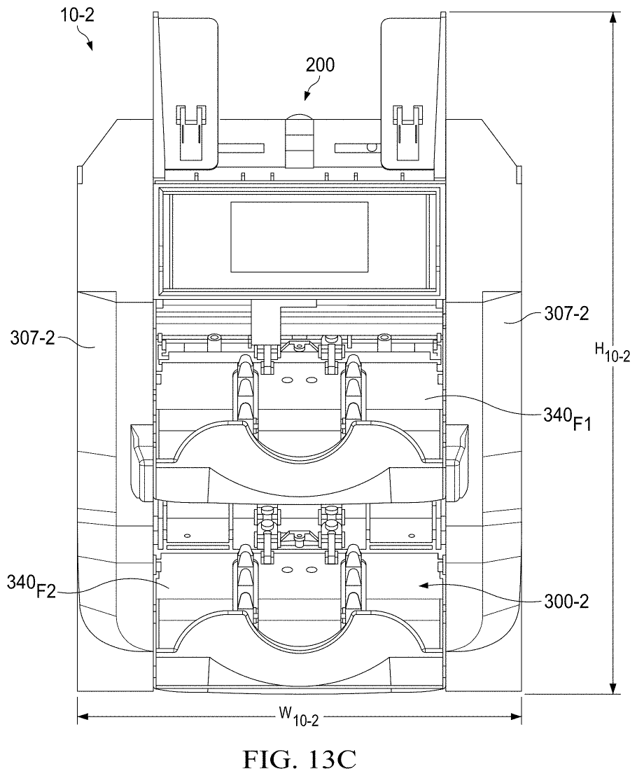

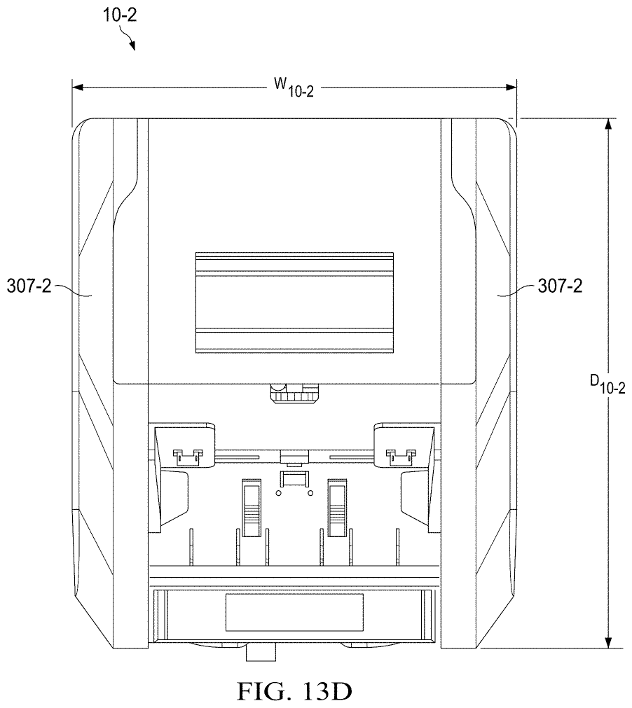

FIGS. 13A-13D illustrate various views of an example banknote processing device 10-2 in accordance with various embodiments of this disclosure. FIG. 13A illustrates a perspective view of the banknote processing device 10-2 in accordance with various embodiments of this disclosure. FIG. 13B illustrates a side view of the banknote processing device 10-2 in accordance with various embodiments of this disclosure. FIG. 13C illustrates a front view of the banknote processing device 10-2 in accordance with various embodiments of this disclosure. FIG. 13D illustrates a top view of the banknote processing device 10-2 in accordance with various embodiments of this disclosure.

In some embodiments, the banknote processing device 10-2 illustrated in FIGS. 13A-13D the device 10-2 shown in FIG. 6 and/or FIGS. 9C-9I, including a common input and discrimination module 200 and an output receptacle module 300-2 having two full output receptacles 340_{F1}, 340_{F2}. FIGS. 13A-13D show the banknote processing device 10-2 in an operational condition with a first and second side cover 307-2 coupled on first side and a second side of the banknote processing device 10-2, respectively. According to some embodiments, the device 10-2 has a height H₁₀₋₂ of about or less than about 18.9 inches, a width W₁₀₋₂ of about or less than about 12.4 inches, and a depth D₁₀₋₂ of about or less than about 14.6 inches, a footprint of about or less than about 181 square inches (1.3 square feet), and a volume about or less than about 3420 cubic inches (2.0 cubic feet). According to some embodiments, the device 10-2 has a height H₁₀₋₂ of about or less than about 19 inches, a width W₁₀₋₂ of about or less than about 13 inches, and a depth D₁₀₋₂ of about or less than about 15 inches, a footprint of about or less than about 195 square inches (1.4 square feet), and a volume about or less than about 3700 cubic inches (2.2 cubic feet).

According to some embodiments, banknotes to be transported by the transport mechanisms 270, 370 are generally rectangularly shaped having two generally parallel wide or long edges and two generally orthogonal narrow or short edges and two banknote surfaces or faces. According to some embodiments, the banknote transport mechanisms 270, 370 are employed to transport banknotes in a wide-edge leading manner. According to some embodiments, the banknote transport mechanisms 270, 370 are configured to transport U.S. banknotes.

According to some embodiments, the transport mechanisms 270, 370 are operated at high speeds and can transport banknotes at a rate of at least 1000 banknotes per minute along the transport path such as, for example, at a rate of at least 1000 U.S. banknotes per minute in a wide-edge leading manner.

According to some embodiments, the transport mechanisms 270, 370 transport banknotes at a rate of at least 600 banknotes per minute along the transport path such as, for example, at a rate of at least 600 U.S. banknotes per minute in a wide-edge leading manner.

According to some embodiments, the transport mechanisms 270, 370 transport banknotes at a rate of at least 800 banknotes per minute along the transport path such as, for example, at a rate of at least 800 U.S. banknotes per minute in a wide-edge leading manner.

According to some embodiments, the transport mechanisms 270, 370 transport banknotes at a rate of at least 1200 banknotes per minute along the transport path such as, for example, at a rate of at least 1200 U.S. banknotes per minute in a wide-edge leading manner.

According to some embodiments, the transport mechanisms 270, 370 transport banknotes at a rate of at least 1400 banknotes per minute along the transport path such as, for example, at a rate of at least 1400 U.S. banknotes per minute in a wide-edge leading manner.

It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A banknote processing device comprising:
an output receptacle module, including:
side walls, each side wall including a flange, wherein each flange includes an aperture;
a first transport plate; and
a transport motor; and
a common input and discrimination module including:
a shaft releasably received in the aperture of each flange of the side walls of the output receptacle module;
a drive shaft having one or more driven rollers coupled thereto; and
a second transport plate which together with the first transport plate of the output receptacle module defines a transport path between the first and second transport plates,
wherein the one or more driven rollers move banknotes along the transport path between the second and first transport plates.

2. The banknote processing device of claim 1, wherein the common input and discrimination module is pivotally mounted about the drive shaft to permit the common input and discrimination module to be moved from an operational position to a non-operational position,
wherein when the common input and discrimination module is positioned in the operational position, the first and second transport plates are spaced slightly apart from each other and the driven rollers extend through openings in the second transport plate into the transport path between the first and second transport plates, and
wherein when the common input and discrimination module is positioned in the non-operational position, at least portions of the first and second transport plates are moved away from each other to provide access to the transport path.

3. The banknote processing device of claim 2, wherein the output receptacle module further includes a full output receptacle, the full output receptacle including a stacking wheel associated therewith to assist with stacking banknotes in the full output receptacle.

4. The banknote processing device of claim 2, wherein the output receptacle module further includes a full output receptacle and a partial output receptacle, the full output receptacle including a stacking wheel associated therewith to assist with stacking banknotes in the full output receptacle, and the partial output receptacle not including a stacking wheel associated therewith.

5. The banknote processing device of claim 4, wherein the output receptacle module further includes a diverter operable to move between a first position and a second position, wherein, when in the first position, the diverter diverts banknotes to a first portion of the transport path leading to the partial output receptacle, and wherein, when in the second position, the diverter diverts banknotes to a second portion of the transport path leading to the full output receptacle.

6. The banknote processing device of claim 2, wherein the output receptacle module further includes two full output receptacles, each full output receptacle including a stacking wheel associated therewith to assist with stacking banknotes in the associated full output receptacle.

7. The banknote processing device of claim 6, wherein the output receptacle module further includes a diverter operable to move between a first position and a second position, wherein, when in the first position, the diverter diverts banknotes to a first portion of the transport path leading to one of the full output receptacles, and wherein, when in the second position, the diverter diverts banknotes to a second portion of the transport path leading to another one of the full output receptacles.

8. The banknote processing device of claim 2, wherein the output receptacle module further includes a partial output receptacle and two full output receptacles, each full output receptacle including a stacking wheel associated therewith to assist with stacking banknotes in the associated full output receptacle, and the partial output receptacle not including a stacking wheel associated therewith.

9. The banknote processing device of claim 8, wherein the output receptacle module further includes:
a first diverter operable to move between a first position and a second position, wherein, when in the first position, the first diverter diverts banknotes to a first portion of the transport path leading to the partial output receptacle, and wherein, when in the second position, the first diverter diverts banknotes to a second portion of the transport path leading to the full output receptacles; and
a second diverter operable to move between a third position and a fourth position, wherein, when in the third position, the second diverter diverts banknotes to a third portion of the transport path leading to one of the full output receptacles, and wherein, when in the fourth position, the second diverter diverts banknotes to a fourth portion of the transport path leading to another one of the full output receptacles.

10. An output receptacle module for a banknote processing device, the output receptacle module comprising:
side walls, each side wall including a flange, wherein each flange includes an aperture into which a shaft of a common input and discrimination module is releasably received;
a first transport plate which together with a second transport plate of the common input and discrimination module defines a transport path between the second and first transport plates;
a transport motor operable to drive a plurality of rollers to transport banknotes along the transport path; and
one or more output receptacles disposed at an end of the transport path and operable to receive the transported banknotes.

11. The output receptacle module of claim 10, wherein the one or more output receptacles includes a full output receptacle, the full output receptacle including a stacking wheel associated therewith to assist with stacking banknotes in the full output receptacle.

12. The output receptacle module of claim 10, wherein the one or more output receptacles includes a full output receptacle and a partial output receptacle, the full output receptacle including a stacking wheel associated therewith to assist with stacking banknotes in the full output receptacle, and the partial output receptacle not including a stacking wheel associated therewith.

13. The output receptacle module of claim 12, further comprising a diverter operable to move between a first position and a second position, wherein, when in the first position, the diverter diverts banknotes to a first portion of the transport path leading to the partial output receptacle, and wherein, when in the second position, the diverter diverts banknotes to a second portion of the transport path leading to the full output receptacle.

14. The output receptacle module of claim 10, wherein the one or more output receptacles includes two full output receptacles, each full output receptacle including a stacking wheel associated therewith to assist with stacking banknotes in the associated full output receptacle.

15. The output receptacle module of claim 14, further comprising a diverter operable to move between a first position and a second position, wherein, when in the first position, the diverter diverts banknotes to a first portion of the transport path leading to one of the two full output receptacles, and wherein, when in the second position, the diverter diverts banknotes to a second portion of the transport path leading to another one of the two full output receptacles.

16. The output receptacle module of claim 10, wherein the one or more output receptacles includes a partial output receptacle and two full output receptacles, each full output receptacle including a stacking wheel associated therewith to assist with stacking banknotes in the associated full output receptacle, and the partial output receptacle not including a stacking wheel associated therewith.

17. The output receptacle module of claim 16, further comprising:
a first diverter operable to move between a first position and a second position, wherein, when in the first position, the first diverter diverts banknotes to a first portion of the transport path leading to the partial output receptacle, and wherein, when in the second position, the first diverter diverts banknotes to a second portion of the transport path leading to the two full output receptacles; and
a second diverter operable to move between a third position and a fourth position, wherein, when in the third position, the second diverter diverts banknotes to a third portion of the transport path leading to one of the two full output receptacles, and wherein, when in the fourth position, the second diverter diverts banknotes to a fourth portion of the transport path leading to another one of the two full output receptacles.

18. The output receptacle module of claim 10, wherein the side walls further include guide flanges including elongated slots for receiving guide posts of the common input and discrimination module, wherein the elongated slots allow for guide posts to move within the elongated slots when the common input and discrimination module moves to a raised position.

19. A method of a banknote processing device, the banknote processing device including an output receptacle module including a first transport plate and side walls that each include a flange having an aperture therethrough, the banknote processing device further including a common input and discrimination module including a second transport plate and a shaft releasably received in the aperture of each flange of the side walls of the output receptacle module, the method comprising:
rotating the common input and discrimination module about the shaft releasably received into the apertures of the side walls of the output receptacle module into an operational position;
receiving, by the common input and discrimination module, one or more banknotes;
transporting the one or more banknotes along a transport path from the common input and discrimination module to the output receptacle module, wherein the transport path is defined by the second transport plate of the common input and discrimination module and the first transport plate of the output receptacle module; and
transporting the one or more banknotes along the transport path to at least one output receptacle of the output receptacle module.

20. The method of claim 19, wherein the at least one output receptacle includes a plurality of output receptacles, and wherein transporting the one or more banknotes includes:
moving a diverter included within the output receptacle module and disposed at a position in the transport path between a first position and a second position;
diverting, when the diverter is in the first position, at least one banknote of the one or more banknotes to a first portion of the transport path leading to one of the plurality of output receptacles; and
diverting, when the diverter is in the second position, at least one banknote of the one or more banknotes to a second portion of the transport path leading to another one of the plurality of output receptacles.
